(19) United States
(12) Patent Application Publication
(10) Pub. No.: US 2023/0196401 A1
(43) Pub. Date: Jun. 22, 2023

(54) METHODS, SYSTEMS, AND DEVICES FOR MANAGING INFORMATION BETWEEN MERCHANTS, INTERMEDIARIES AND/OR END USERS

(71) Applicant: Simon Kai-tse CHEONG, Singapore (SG)

(72) Inventor: Simon Kai-tse CHEONG, Singapore (SG)

(21) Appl. No.: 17/924,970

(22) PCT Filed: May 13, 2020
(86) PCT No.: PCT/SG2020/050276

§ 371 Date: Nov. 11, 2022

(51) Int. Cl. G06Q 30/0226; G06Q 20/40; G06Q 20/10; G06Q 20/36; G06Q 20/32

(52) U.S. Cl. CPC G06Q 30/0233; G06Q 20/4015; G06Q 20/10; G06Q 20/36; G06Q 20/3276

(57) ABSTRACT

Embodiments relate to methods and systems for managing information between merchants, intermediaries, and/or end users. The method includes providing a first detectable identifier for a first unit of a product. First detectable identifier is different from a second detectable identifier for a second unit of the product. First detectable identifier includes instructions which, when detected by a user device, causes the user device to send a redemption request. Responsive to receiving the redemption request from a user device, performing a redemption process. Redemption process includes obtaining an information payload for the first unit of the product. Information payload includes a redemption reward; and a redemption status. Redemption status is an unredeemed status or redeemed status. Redemption process includes identifying the redemption status for the information payload. Responsive to a determination that the redemption status is the unredeemed status, the redemption process includes transferring, to the user, the redemption reward.

### TECHNICAL FIELD

The present disclosure relates generally to managing of information, and more specifically, to methods, systems, devices, and logic for managing information between merchants, intermediaries, and/or end users.

### BACKGROUND

Logistics companies have long enabled companies, including manufacturers, producers, and other merchants, to ship and sell their products anywhere in the world. Products are typically shipped and/or sold to distribution centres, wholesalers, and/or large retail chains or supermarkets. From there, consumers (or end users) are then able to purchase and take home such products. Recently, new companies have emerged, providing solutions for the “last mile” of service, that is, for shipping and delivery of products to end users in an affordable and convenient manner. Examples include, but are not limited to, e-commerce shops like Amazon. com, Alibaba, etc.; online grocery stores like RedMart, Whole Foods, etc.; online food delivery services like Uber Eats, Grab Food, Deliveroo, FoodPanda, JustEat, etc.

### BRIEF SUMMARY

Despite recent technological advances and widespread availability of companies that provide “last mile” or “micro” shipping and/or delivery of products to end users in affordable and convenient ways (such companies referred to herein as “intermediaries”), it is recognized in the present disclosure that such “last mile” or “micro” services introduce and/or cause certain problems. For example, while such services provide end users the convenience of fast delivery to anywhere location (home, work, etc.), the manufacturers, producers, originators, restaurants, and other merchants (such companies referred to herein as “merchants”) of such products and/or food have become increasingly “detached”, separated, removed, or the like, from their end users. As a result, such merchants are finding it increasingly difficult to learn more about and/or engage with their end users. Instead, the intermediaries are becoming increasingly empowered with information about such end users, including their purchases, preferences, habits, and locations.

Present example embodiments relate generally to and/or include systems, subsystems, processors, devices, logic, methods, and processes for managing information between merchants, intermediaries, and/or end users.

In an exemplary embodiment, a method of managing transactions made by end users is described. The method includes generating, by a processor, an information payload for each of a plurality of units of a first product. The method includes generating a first unit information payload for a first unit of the first product. The first unit information payload for the first unit of the first product is different from a second unit information payload for a second unit of the first product. The first unit information payload for the first unit of the first product includes a first unique identifier for the first unit information payload, a first redemption reward for the first unit of the first product, and a first redemption status for the first unit information payload. The first redemption reward is a digital asset representing a reward redeemable by a user who has purchased the first unit of the first product. The first redemption reward is configured to be transferrable, by the processor, to one of a plurality of users who has purchased the first unit of the first product based on a redemption verification process. The first redemption status for the first unit information payload is an unredeemed status when the first redemption reward has not yet been transferred to any of the plurality of users. The first redemption status for the first unit information payload is a redeemed status when the first redemption reward has been transferred to one of the plurality of users. The method includes generating, by the processor, a unique detectable identifier for each information payload. The method includes generating a first detectable identifier for the first unit information payload. The first detectable identifier is associated with the first unique identifier for the first unit information payload. The first detectable identifier is configured to cause a user device to perform a first action when the first detectable identifier is detected by the user device. The first action includes sending, to the processor, a first redemption request. The first redemption request includes the first unique identifier for the first unit information payload. Responsive to receiving, by the processor, the first redemption request from a first user device of a first user, the method includes performing the redemption verification process for the first redemption request. The redemption verification process includes obtaining a first user information set for the first user; obtaining, based on the first unique identifier for the first unit information payload in the first redemption request, the first unit information payload; identifying the first redemption status for the first unit information payload. Responsive to a determination that the first redemption status for the first unit information payload is the unredeemed status: transferring, by the processor to the first user based on the first user information set, the first redemption reward for the first unit information payload; and setting the first redemption status for the first unit information payload to be the redeemed status. Responsive to a determination that the first redemption status for the first unit information payload is the redeemed status: sending, by the processor to the first user, a notification that the first redemption reward has already been redeemed.

In another exemplary embodiment, a method of managing transactions made by end users is described. The method includes generating, by a processor, an information payload for each of a plurality of units of a first product. The method includes generating a first unit information payload for a first unit of the first product. The first unit information payload for the first unit of the first product is different from a second unit information payload for a second unit of the first product. The first unit information payload for the first unit of the first product includes a first unique identifier for the first unit information payload; and a first redemption reward metric for the first unit of the first product. The first redemption reward metric identifies a plurality of available digital rewards transferrable, by the processor, to a user based on a redemption process. The method includes generating, by the processor, a unique detectable identifier for each information payload. The method includes generating a first detectable identifier for the first unit information payload. The first detectable identifier is associated with the first unique identifier for the first unit information payload. The first detectable identifier is configured to cause a user device to perform a first action when the first detectable identifier is detected by the user device. The first action includes sending, to the processor, a first redemption request. The first redemption request includes the first unique identifier for the first unit information payload. Responsive to receiving, by the processor, the first redemption request from a first user device of a first user, the method includes performing the redemption process for the first redemption request. The redemption process includes obtaining a first user information set for the first user; obtaining, based on the first unique identifier for the first unit information payload in the first redemption request, the first unit information payload; selecting, based on the first user information set for the first user, a first digital reward from among the plurality of digital rewards in the first redemption reward metric; and transferring, by the processor to the first user, the selected first digital reward.

In another exemplary embodiment, a method of managing transactions made by end users is described. The method includes providing a first detectable identifier for a first unit of a first product. The first detectable identifier for the first unit of the first product is different from a second detectable identifier for a second unit of the first product. The first detectable identifier includes instructions which, when detected by a user device, causes the user device to send, to a processor, a first redemption request. Responsive to receiving, by the processor, the first redemption request from a first user device of a first user, the method includes performing a redemption verification process for the first redemption request. The redemption verification process includes obtaining, based on the first redemption request, a first unit information payload for the first unit of the first product. The first unit information payload includes a first redemption reward for the first unit of the first product; and a first redemption status. The first redemption status is an unredeemed status or a redeemed status. The redemption verification process includes identifying the first redemption status for the first unit information payload. Responsive to a determination that the first redemption status is the unredeemed status, the redemption verification process includes transferring, by the processor to the first user, the first redemption reward.

In another exemplary embodiment, a method of managing transactions made by end users is described. The method includes providing a first unique QR code for a first unit of a first product. The first unique QR code for the first unit of the first product is different from a second unique QR code for a second unit of the first product. The first unique QR code includes instructions which, when scanned by a user device, causes the user device to send, to a processor, a first redemption request. Responsive to receiving, by the processor at a first time, the first redemption request from a first user device of a first user, the method includes performing a redemption verification process for the first redemption request. The redemption verification process includes obtaining, based on the first redemption request, a first unit information payload for the first unit of the first product. The first unit information payload includes a first redemption reward for the first unit of the first product; and a first redemption status. The first redemption status is an unredeemed status when the processor has not received the first redemption request prior to the first time. The first redemption status is a redeemed status when the processor has received the first redemption request before the first time. The redemption verification process includes identifying the first redemption status for the first unit information payload. Responsive to a determination that the first redemption status is the unredeemed status, the redemption verification process includes transferring, by the processor to the first user, the first redemption reward.

In another exemplary embodiment, a method of managing transactions made by end users is described. The method includes providing a first detectable identifier for a first unit of a first product. The first detectable identifier is associated with a first unique identifier for the first unit of the first product. The first detectable identifier is configured to cause a user device to perform a first action when the first detectable identifier is detected by the user device. The first action includes sending, to a processor, a first redemption request. The first redemption request includes the first unique identifier for the first unit of the first product. The method includes providing a second detectable identifier for a second unit of the first product. The second detectable identifier is associated with a second unique identifier for the second unit of the first product. The second detectable identifier is configured to cause the user device to perform a second action when the second detectable identifier is detected by the user device. The second action includes sending, to the processor, a second redemption request. The second redemption request includes the second unique identifier for the second unit of the first product. Responsive to receiving, by the processor at a first time, the first redemption request from a first user device of a first user, the method includes performing a first redemption process for the first redemption request. The first redemption process includes obtaining a first user information set for the first user. The first redemption process includes obtaining, based on the first unique identifier in the first redemption request, a first unit information payload. The first unit information payload includes the first unique identifier for the first unit of the first product; a first redemption reward for the first unit of the first product; and a first redemption status, the first redemption status being an unredeemed status. Responsive to a determination that the first redemption status is the unredeemed status, the first redemption process includes transferring, by the processor to the first user based on the first user information set, the first redemption reward; and changing the first redemption status for the first unit information payload from the unredeemed status to the redeemed status. Responsive to receiving, by the processor at a second time after the first time, the first redemption request from the first user device of the first user, the method includes performing the first redemption process for the first redemption request. The first redemption process includes obtaining the first user information set for the first user. The first redemption process includes obtaining, based on the first unique identifier in the first redemption request, the first unit information payload. The first unit information payload includes the first unique identifier for the first unit of the first product; the first redemption reward for the first unit of the first product; and the first redemption status, the first redemption status being the redeemed status. Responsive to a determination that the first redemption status is the redeemed status, the first redemption process includes sending, by the processor to the first user, a notification that the first redemption reward for the second unit of the first product has already been redeemed. Responsive to receiving, by the processor at a third time, the second redemption request from the first user device of the first user, the method includes performing a second redemption process for the second redemption request. The second redemption process includes obtaining the first user information set for the first user. The second redemption process includes obtaining, based on the second unique identifier in the second redemption request, a second unit information payload. The second unit information payload includes a second redemption reward for the second unit of the first product; and a second redemption status, the second redemption status being the unredeemed status. Responsive to a determination that the first redemption status is the unredeemed status, the second redemption process includes transferring, by the processor to the first user based on the first user information set, the second redemption reward; and changing the second redemption status for the second unit information payload from the unredeemed status to the redeemed status. Responsive to receiving, by the processor at a fourth time after the first time, the first redemption request from a second user device of a second user, the method includes performing the first redemption process for the first redemption request. The first redemption process includes obtaining a second user information set for the second user. The first redemption process includes obtaining, based on the first unique identifier in the first redemption request, the first unit information payload. The first unit information payload includes the first redemption reward for the first unit of the first product; and the first redemption status, the first redemption status being the redeemed status. Responsive to a determination that the first redemption status is the redeemed status, the first redemption process includes sending, by the processor to the second user, a notification that the first redemption reward for the first unit of the first product has already been redeemed. Responsive to receiving, by the processor at a fifth time after the third time, the second redemption request from the second user device of the second user, performing the second redemption process for the second redemption request. The second redemption process includes obtaining the second user information set for the second user. The second redemption process includes obtaining, based on the second unique identifier in the second redemption request, the second unit information payload. The second unit information payload includes the second redemption reward for the second unit of the first product; and the second redemption status, the second redemption status being the redeemed status. Responsive to a determination that the second redemption status is the redeemed status, the second redemption process includes sending, by the processor to the second user, a notification that the second redemption reward for the second unit of the first product has already been redeemed.

### BRIEF DESCRIPTION OF THE FIGURES

For a more complete understanding of the present disclosure, example embodiments, and their advantages, reference is now made to the following description taken in conjunction with the accompanying figures, in which like reference numbers indicate like features, and:

FIG. 1 is an illustration of an example embodiment of a system for managing information between merchants, intermediaries, and users;

FIG. 2 is an illustration of an example embodiment of a processor for managing information between merchants, intermediaries, and users;

FIG. 3 is an illustration of an example embodiment of a setup processor;

FIG. 4 is an illustration of an example embodiment of a redemption processor;

FIG. 5 is an illustration of an example embodiment of a consumption processor;

FIG. 6 is an illustration of an example embodiment of a main processor;

FIG. 7 is an illustration of an example embodiment of a method of performing a configuration or setup process;

FIG. 8 is an illustration of an example embodiment of a method of performing a redemption process; and

FIG. 9 is an illustration of an example embodiment of a method of performing a consumption process.

Although similar reference numbers may be used to refer to similar elements in the figures for convenience, it can be appreciated that each of the various example embodiments may be considered to be distinct variations.

Example embodiments will now be described with reference to the accompanying figures, which form a part of the present disclosure and which illustrate example embodiments which may be practiced. As used in the present disclosure and the appended claims, the terms “embodiment,” “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on,” and the terms “a,” “an,” and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon,” depending on the context. Furthermore, as used in the present disclosure and the appended claims, the words “and/or” may refer to and encompass any and all possible combinations of one or more of the associated listed items.

### DETAILED DESCRIPTION

Logistics and shipping companies alike have long enabled manufacturers, producers, and other merchants to distribute their products anywhere in the world. Products are typically provided to distribution centres, wholesalers, and/or large retail chains or supermarkets, who then offer such products to end users. A new breed of companies have emerged over recent years that provide “last mile” or micro-delivery services at affordable prices. Examples include, but are not limited to, e-commerce shops like Amazon. com, Alibaba, etc.; online grocery stores like RedMart, Whole Foods, etc.; online food delivery services like Uber Eats, Grab Food, Deliveroo, FoodPanda, JustEat, etc.

Despite recent technological advances and widespread availability of such intermediary companies that provide such “last mile” or “micro-delivery” services of products to end users in affordable and convenient ways, it is recognized in the present disclosure that certain problems are introduced and/or encountered. For example, while such intermediary services provide end users the convenience of fast delivery to anywhere location (home, work, etc.), the merchants of such products and/or food have become increasingly detached, separated, removed, or the like, from their end users. As a result, such merchants are finding it increasingly difficult to learn more about and/or engage directly with their end users. Instead, such intermediaries are becoming increasingly empowered with information about and direct access to end users.

Present example embodiments relate generally to and/or include systems, subsystems, processors, devices, logic, methods, and processes for addressing conventional problems, including those described above and in the present disclosure, and more specifically, example embodiments relate to systems, subsystems, processors, devices, logic, methods, and processes for managing of information between merchants, intermediaries, and/or end users. It is to be understood in the present disclosure that one or more elements and/or aspects of example embodiments may include and/or be implement, in part or in whole, solely and/or in cooperation with other elements, using, for example, networking technologies, cloud computing, distributed ledger technology (DLT) (e.g., blockchain), artificial intelligence (AI), machine learning, deep learning, etc.

As used in the present disclosure, a “merchant”, or the like, includes, but is not limited to, a person and/or entity who manufactures, produces, assembles, packages, creates, compiles, modifies, adapts, reproduces, sells, distributes, imports, and/or makes available in any other way a product, or the like, (also referred to herein as “provide”, “provides”, “provided”, or the like) for intermediaries to sell, resell, deliver, etc. to end users (also referred to herein as a user) and/or for users to purchase. A merchant may include, but is not limited to, a restaurant, café, fast food outlet, supermarket, grocery store or platform, packaged or fresh food and/or beverage company, retail store or platform, department store, electronics company and/or retailer, toy company and/or retailer, household goods company and/or retailer, cosmetics and/or beauty products company and/or retailer, clothing and/or apparel company and/or retailer, jewellery and/or accessories company and/or retailer, health products and/or supplements company and/or retailer, medicines/pharmaceuticals company and/or retailer, alcohol company and/or retailer, tobacco company and/or retailer, firearms company and/or retailer, sporting goods company and/or retailer, entertainment and/or events company and/or retailer, homeware/furniture/kitchenware company and/or retailer, etc. A “product” may include, but is not limited to, cooked food, drinks, packaged foods and/or produce, electronics, toys, household goods, cosmetics, beauty products, clothing and other apparel, jewellery and accessories, health products, supplements, medicines, pharmaceuticals, alcohol, tobacco, firearms, sporting goods, services, software, homeware, furniture, kitchenware, etc. Furthermore, an “intermediary”, “service provider”, or the like, includes, but is not limited to, a person or entity who provides and/or is available to provide, sell, resell, deliver, distribute, handle, manage, or the like, one or more products of a merchant, and may include an online retailer or store, a delivery service, a retail store, a supermarket, a superstore, a convenience store, a vending machine, a delivery person, a vehicle (e.g., a vehicle driven by a person, an autonomous or semi-autonomous vehicle, a car, a truck, a bus, a motorcycle, a boat, a plane, etc.), etc. An intermediary may also be a merchant, and vice versa. Furthermore, as used in the present disclosure, a “user”, “first user”, “second user”, “end user”, or the like, includes, but is not limited to, a person or entity who purchases a product from a merchant, purchases a product from an intermediary, uses a product, and/or otherwise receives a product in any other ways (also referred to herein as “receive”, “receives”, “received”, or the like, a product or a unit of a product). A user may also be a merchant and/or intermediary, and vice versa.

Example embodiments will now be described below with reference to the accompanying figures, which form a part of the present disclosure.

Example Embodiments of a System for Managing Information between Merchants, Intermediaries, and/or Users (e.g., system 100).

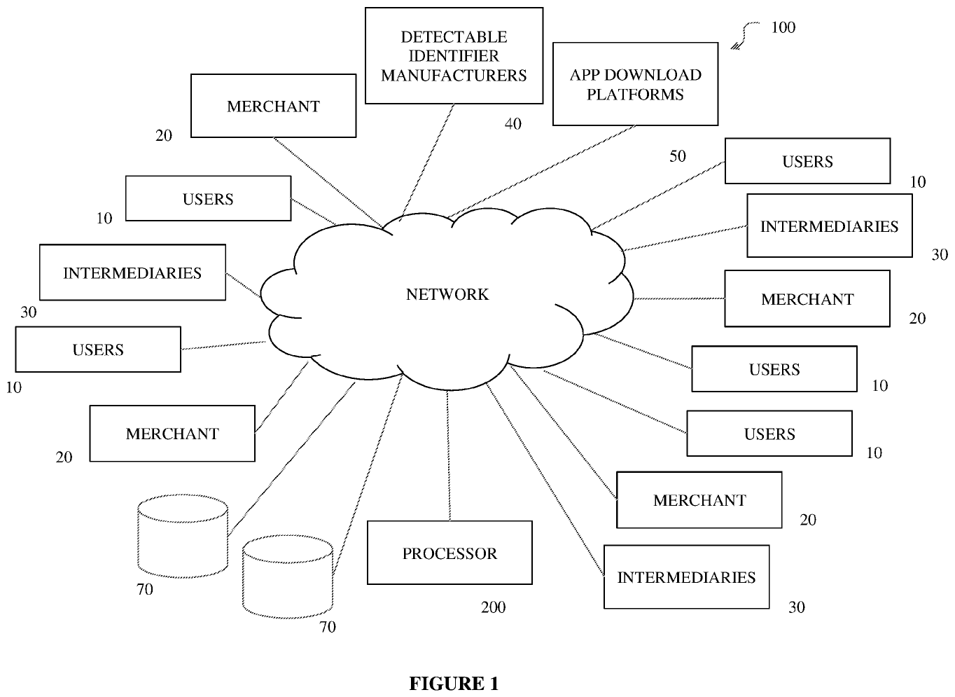

FIG. 1 illustrates an example embodiment of a system (e.g., system 100) for managing information between merchants, intermediaries, and/or users. The system 100 includes one or more elements. For example, the system 100 includes one or more processors (e.g., processor 200). The system 100 may also include and/or communicate with one or more detectable identifier manufacturers 40. The system 100 may also include and/or communicate with one or more application (or “app”) download platforms 50. The system 100 may also include and/or communicate with one or more networks, communication channels, or the like (e.g., communication channels 60), which are used to enable communication between elements of the system 100. The system 100 may also include and/or communicate with one or more databases, distributed ledgers, or the like (e.g., database 70) to store, search, and/or retrieve information and/or digital assets.

The system 100 is configurable or configured to communicate with one or more users 10, user devices 10, and/or other devices 10. As used in the present disclosure, references to a user 10 may also include a device of the user 10 (or user device 10), and vice versa. User devices 10 may include, but are not limited to, mobile phones, tablets, wearable devices (e.g., smart watches, smart glasses, smart earphones and headphones, smart speakers, etc.), etc. User devices 10 are configurable or configured to perform, among other things, a downloading and installing of applications (or “apps” or software programs), or the like. User devices 10 are also configurable or configured to download and install electronic wallets, or the like, for storing digital assets (e.g., redemption rewards). It is to be understood in the present disclosure that such electronic wallets may be integrated in and/or cooperate with apps, and vice versa. As will be further described in the present disclosure, user devices 10 are also configurable or configured to detect, scan, receive, communicate with, read, interpret, identify, or the like, (also referred to herein as “detect”, “detects”, “detectable”, “detected”, or the like) one or more detectable identifiers provided for and/or assigned to products. As used in the present disclosure, a “detectable identifier” may include, but is not limited to, a device, object, article, signal, image/graphic, and/or series of characters detectable by user devices 10. Detectable identifiers may be manufactured, created, printed, and/or otherwise provided by detectable identifier manufacturers 40, merchants 20, and/or intermediaries 30. Alternatively or in addition, detectable identifiers may be dynamically generated (e.g., when a user device 10 detects the product). As will be further described in the present disclosure, detectable identifiers may be provided in one or more of a variety of ways, shape, and/or form including, but not limited to, a QR code, barcode, series of characters, NFC tag/chip, RFID tag, etc. For example, when a detectable identifier is a QR code, user devices 10 having an image capturing device (e.g., a camera) are configurable or configured to detect the QR code and cause the user device 10 to perform one or more functions and/or actions (e.g., when the QR code includes a deep link, or the like, the user device 10 may initiate a browser or mobile application to launch/open the link and pass on certain information to the processor 200 for further processing/action; the user device 10 may also initiate an app download platform 50 (e.g., Apple App Store, Google Play Store, etc.) to allow the user to download an app and/or electronic wallet). Each user device 10 of a user 10 is also configurable or configured to receive/redeem, transfer, use/consume and/or otherwise keep track of ownership of digital assets, or the like, that represent redemption rewards provided, by merchants 20 and/or intermediaries 30 to the user 10, for the user's 10 purchasing of products.

The system 100 is also configurable or configured to communicate with one or more merchants 20. For example, communications from a merchant 20 to the processor 200 may include providing the processor 200 with a request to generate a unique detectable identifier for each of a plurality of units of a product (e.g., a cereal manufacturer requesting to generate unique QR codes for each of 50,000 boxes of cereal). In providing such a request, the merchant 20 may provide information including, but not limited to, merchant information, information on the product, quantity of units, redemption reward(s) to be provided to users 10 who purchase a unit of the product, expiry dates, geolocation restrictions, etc. The merchant 20 may also indicate what information to collect from the user 10 and/or how the merchant 20 will communicate with the user 10.

The system 100 is also configurable or configured to communicate with one or more intermediaries 30. For example, communications from an intermediary 30 to the processor 200 may include providing the processor 200 with a request to generate a unique detectable identifier for each of a plurality of units of a product (e.g., a supermarket requesting to generate unique QR codes for each of 50,000 boxes of cereal). In providing such a request, the intermediary 30 may provide information including, but not limited to, intermediary information, information on the product, quantity of units, redemption reward(s) to be provided to users 10 who purchase a unit of the product, expiry dates, geolocation restrictions, etc. The intermediary 30 may also indicate what information to collect from the user 10 and/or how the intermediary 30 will communicate with the user 10.

Although the figures may illustrate the system 100 as having one processor 200, it is to be understood that the system 100 may include more than one processor 200 without departing from the teachings of the present disclosure. Each processor 200 is configurable or configured to connect to, communicate with, and/or receive information from one or more users 10, one or more user devices 10, one or more merchants 20, one or more intermediaries 30, one or more detectable identifier manufacturers 40, one or more app download platforms 50, one or more networks 60, one or more databases and/or distributed ledgers 70, and/or one or more other processors 200.

As used in the present disclosure, when applicable, a reference to a system (e.g., system 100) or processor (e.g., processor 200) may also refer to, apply to, and/or include one or more computing devices, processors, servers, systems, cloud-based computing, or the like, and/or functionality of one or more processors, computing devices, servers, systems, cloud-based computing, or the like. The system 100 and/or processor 200 (and/or its elements, as described in the present disclosure) may be any processor, server, system, device, computing device, controller, microprocessor, microcontroller, microchip, semiconductor device, or the like, configurable or configured to perform, among other things, a processing and/or managing of information, searching for information, identifying of information, data communications, and/or any one or more other actions described above and in the present disclosure. Alternatively or in addition, the system 100 and/or processor 200 (and/or its elements, as described in the present disclosure) may include and/or be a part of a virtual machine, processor, computer, node, instance, host, or machine, including those in a networked computing environment. As used in the present disclosure, a communication channel 60, network 60, cloud 60, or the like, may be or include a collection of devices and/or virtual machines connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A communication channel 60, network 60, cloud 60, or the like, may include, but is not limited to, the internet, intranets, WiFi systems, GPS systems, location systems, location-based service systems, computing grid systems, peer to peer systems, mesh-type systems, distributed computing environments, cloud computing environment, telephony systems, voice over IP (VoIP) systems, etc. Such communication channels 60, networks 60, clouds 60, or the like, may include hardware and software infrastructures configured to form a virtual organization comprised of multiple resources which may be in geographically disperse locations. Communication channel 60, network 60, cloud 60, or the like, may also refer to a communication medium between processes on the same device. Also as referred to herein, a network element, node, or server may be a device deployed to execute a program operating as a socket listener and may include software instances.

These and other elements of the system 100 will now be further described with reference to the accompanying figures.

The Processor (e.g., processor 200).

As illustrated in FIG. 1, the system 100 includes one or more processors (e.g., processor 200). The processor 200 is configurable or configured to manage and/or process, among other things, information between merchants 20, intermediaries 30, and/or users 10. For example, the processor 200 is configurable or configured to enable merchants 20 and/or intermediaries 30 to gather and/or process information regarding users 10 who purchase, use, and/or otherwise receive products (and/or services) provided by the merchants 20 and/or intermediaries 30. The processor 200 is also configurable or configured to enable merchants 20 and/or intermediaries 30 to gather and/or process information regarding transactions made by users 10, directly or indirectly, of such products provided by the merchants 20 and/or intermediaries 30. The processor 200 is also configurable or configured to enable merchants 20 and/or intermediaries 30 to gather and/or process information regarding rewards given to, transferred to, transferrable to, received by, receivable by, earned by, earnable by, entitled by, available to, redeemed by, and/or redeemable by (also referred to herein as “redeem”, “redeems”, “redeemable”, “redeemed”, or the like) users 10 who have purchased, used, and/or otherwise received one or more units of such products (such rewards also referred to herein as “redemption rewards”, “redeemable rewards”, or the like). Redemption rewards include, but are not limited to, digital assets, including digital stamps (e.g., virtual, digital, encrypted, and/or cryptographic version of a frequent buyer program, or the like, in which a user 10 collects a certain quantity of digital stamps to receive something in return (e.g., a free, discounted, promotional, and/or special product, service, access or admission to an event, membership level, or the like)), digital badges (e.g., similar to digital stamps, but in the form of virtual, digital encrypted, and/or cryptographic badges), digital tokens, cryptocurrencies, or the like. The processor 200 is also configurable or configured to enable users 10 who have earned such redemption rewards to transact, exchange, spend, consume, convert, apply, and/or otherwise use (also referred to herein as “consume”, “consumable”, “consumed”, or the like) such redemption rewards for something (e.g., a free, discounted, promotional, and/or special product, service, access or admission to an event, membership level, or the like).

The processor 200 is configurable or configured to perform, or assist or cooperate with a user device 10 in performing, a configuration or setup process for users 10. After performing the configuration or setup process, users 10 may, via their user devices 10, request, receive, and/or consume redemption rewards for products (and/or services) purchased, used, and/or otherwise received by the user 10. The configuration or setup process may include receiving, by the processor 200, a configuration or setup request from a user 10. Such a configuration or setup request may be sent by a user 10 in one or more ways. For example, the configuration or setup process may include downloading and installing a software application (e.g., a mobile app, or the like, such as the Flex Rewards app available on the Apple App Store and Google Play Store, or the like) on the user device 10, and the configuration or setup request may be sent via such mobile app. Either during or after sending the configuration or setup request, the user 10 may provide certain information to the processor 200 including, but not limited to, one or more of the following: name of the user 10 (e.g., legal name, first name, last name, middle name or initial, etc.), email address, social media handle or login (e.g., Facebook, Google, etc.), user name, password, date of birth, gender, preferences and/or interests, residential address (which may include geolocations), supporting identification (e.g., passport, national ID, NRIC, driver's license, etc.), proof of address (e.g., bank statement, utility bill, etc.), existing electronic wallet, or the like, etc. In an example embodiment, the user 10 may download the mobile app by launching a software download app of an app download platform 50, or the like, such as the Apple App Store, Google Play Store, etc. Alternative or in addition, as will be further described in the present disclosure, a user 10 may use his/her user device 10 to detect an example embodiment of a detectable identifier, which is configurable or configured to cause user devices 10 to perform an action. As a more specific example, the detectable identifier may be a QR code with one or more deep link URLs, in which case the user device 10 may use its image capturing device (e.g., built-in camera) to scan (i.e., detect) the QR code (i.e., detectable identifier) and direct the user device 10 to launch/open a download page of the mobile app on a preferred software download app of an app download platform 50 (i.e., the action) to download the mobile app (e.g., without requiring the user 10 manually launch the software download app and search for the mobile app). Other methods, ways, and/or forms of sending a configuration or setup request are also contemplated without departing from the teachings of the present disclosure. For example, the user 10 may send the configuration or setup request via a website (e.g., the configuration or setup request is sent through an internet browser), email, mail, fax, etc. In situations where the user 10 does not already have an electronic wallet, or the like, for receiving redemption rewards, the configuration or setup process may include downloading, installing, and/or otherwise configuring an electronic wallet, or the like, on the user device 10.

As described in the present disclosure, the processor 200 is also configurable or configured to perform a configuration or setup process for merchants 20 and/or intermediaries 30. After performing the configuration or setup process, merchants 20 and/or intermediaries 30 may manage and/or process, among other things, information regarding users 10; information regarding transactions (e.g., purchases, uses, and/or receiving) by users 10 of products (and/or services) provided by the merchants 20 and/or intermediaries 30; redemption rewards redeemable and/or redeemed by users 10; and/or redemption rewards consumable and/or consumed by users 10. The configuration or setup process includes receiving, by the processor 200, a configuration or setup request from a merchant 20 and/or intermediary 30. The configuration or setup request includes certain information on how the merchant 20 and/or intermediary 30 would like to manage and/or process information pertaining to users 10 who purchase, use, and/or otherwise receive one or more units of products (and/or services) provided by the merchant 20 and/or intermediary 30. For example, the configuration or setup request may include, but is not limited to, one or more of the following information: information regarding the product that will be associated with a redemption reward (e.g., brand, product name, product description, product model number, unique product identifier, etc.); a quantity of units of the product that the merchant 20 and/or intermediary 30 wants to participate in the redemption reward; a redemption reward to be redeemable or redeemed by a user 10 for purchasing, using, and/or otherwise receiving the product (and/or a redemption reward metric, or the like, such as a list of possible/available redemption rewards, criteria or criterion for redeeming each redemption reward, alternative redemption rewards if a main redemption reward has already been redeemed, etc.); geolocation eligibilities and/or restrictions (e.g., specific locations (e.g., residential homes, office buildings, etc.), cities (e.g., only in Sydney), states/provinces, regions, countries (e.g., only in the US), etc. that are eligible to redeem the reward; and/or specific locations (e.g., product distribution centres, supermarkets, department stores, inventory replenishment centres, etc.), cities, states/provinces, regions, countries, etc. that are not eligible to redeem the reward; etc.); temporal eligibilities and/or restrictions (e.g., overall expiry dates, types and/or amounts of redemption rewards redeemable based on specific dates, etc.); user eligibility and/or restrictions (e.g., based on user level, purchase or use history, etc.); etc.

The configuration or setup process for merchants 20 and/or intermediaries 30 may also include generating an information payload, or the like, for each unit of the product (and/or service) based on, among other things, information provided in the configuration or setup request. More specifically, each unit of the product will receive a unique information payload. For example, a merchant 20 may generate a certain quantity of units of a particular product (e.g., 8,000 units of a particular shirt), and all units of the product may (or may not) be identical or indistinguishable from one another. In such an example, a unique information payload is generated for each of the units of the product (e.g., 8,000 unique information payloads for the 8,000 units of the shirt). It is to be understood in the present disclosure that the generating of the information payload may also be based on other information, including, but not limited to, default values/information, preferred values/information of the merchant 20 and/or intermediary 30, etc. In an example embodiment, an information payload may be generated to include, among other things, a unique identifier (e.g., a unique sequence of characters, a hash of the product name plus a unit number (e.g., 1/8000, 2/8000, . . . , 8000/8000), etc.); a redemption reward (and/or a redemption reward metric, or the like, such as a list of possible/available redemption rewards, criteria or criterion for redeeming each redemption reward, alternative redemption rewards if a main redemption reward has already been redeemed, etc.); geolocation eligibilities and/or restrictions (e.g., specific locations (e.g., residential homes, office buildings, etc.), cities (e.g., only in Sydney), states/provinces, regions, countries (e.g., only in the US), etc. that are eligible to redeem the reward; and/or specific locations (e.g., product distribution centres, supermarkets, department stores, inventory replenishment centres, etc.), cities, states/provinces, regions, countries, etc. that are not eligible to redeem the reward; etc.); temporal eligibilities and/or restrictions (e.g., overall expiry dates, types and/or amounts of redemption rewards redeemable based on specific dates, etc.); user eligibility and/or restrictions (e.g., based on user level, purchase or use history, etc.); redemption status (e.g., redeemed status or unredeemed status to indicate whether or not the redemption reward(s) have been redeemed); consumption status (e.g., consumed status or unconsumed status to indicate whether or not the redemption reward(s) have been consumed); gamification options (e.g., in situations where a user 10 is required to participate in a game, or the like, before receiving a redemption reward); information regarding the product that will be associated with a redemption reward (e.g., brand, product name, product description, product model number, unique product identifier, etc.); information regarding the quantity of units of the product that participate in the redemption reward; information regarding the merchant 20 and/or intermediary 30 who is providing the redemption reward to users 10; information regarding the users 10 who are eligible for, who have redeemed, and/or who have consumed the redemption reward.

After the information payloads are generated for each unit of a product, the configuration or setup process then includes generating (or cooperating and/or facilitating the generating of) a detectable identifier, or the like, for each information payload (i.e., a unique detectable identifier for each unit of the product (and/or service)). For the above example in which a merchant 20 plans to sell 8,000 units of a shirt, the configuration or setup process may generate 8,000 detectable identifiers for the 8,000 information payloads (i.e., for the 8,000 units of the shirt). In an example embodiment, a unique detectable identifier is generated for each information payload (i.e., for each shirt). Detectable identifiers may include, but are not limited to, a device, object, article, tag, signal, image/graphic, and/or series of characters detectable (e.g., scannable, receivable, identifiable, etc.) by user devices 10. Examples of detectable identifiers include, but are not limited to, QR codes, barcodes, NFC tags, RFID tags, specific images or graphics detectable by an image capturing device of or associated with a user device 10, specific sequences of characters detectable by an image capturing device of or associated with a user device 10, etc. After the processor 200 generates the detectable identifiers, the processor 200 is configurable or configured to provide the generated detectable identifier to one or more detectable identifier manufacturers 40, who then manufacture (e.g., print, produce, manufacture, etc.) the final detectable identifier to be attached to, printed on, associated with, provided with, etc. (each as applicable) the product. Each detectable identifier is configurable or configured to attach to (e.g., printed on product packaging, printed on a sticker that is attached to the product or product packaging, secured to the product or product packaging when in the form of an NFC tag or RFID tag, etc.), associate with, and/or otherwise provided along with each unit of the product so as to allow a user 10 who has purchased, used, and/or otherwise received the unit of the product to use his/her user device 10 to detect the detectable identifier. The detectable identifier is configurable or configured to cause the user device 10, once it has detected the detectable identifier, to perform one or more actions and/or functions. Such actions may include generating a redemption request, obtaining and passing certain information into the redemption request, and sending the redemption request to the processor 200. For example, such action may include passing on a unique identifier of the particular unit of the product having the detectable identifier to the redemption request processor 232 and/or directly to the processor 200 (note, the unique identifier is also stored in the information payload for the particular unit of the product). For example, when the detectable identifier is a unique QR code printed on a sticker and attached the product, a user device 10 may scan (i.e., detect) via a camera of the user device 10 the QR code (i.e., the detectable identifier), which may include or be associated with a deep link URL, or the like. Such detecting of the detectable identifier may cause the user device 10 to launch/open (i.e., the action) an already installed mobile app (e.g., a dedicated mobile app that the user has previously performed the configuration or setup process, as described above and in the present disclosure), pass the unique identifier to the processor 200 to perform a check if a redemption reward is available for the user 10. In situations where the user device 10 has not yet installed the mobile app, the detecting of the detectable identifier may cause the user device to launch/open (i.e., the action) a download page of the mobile app on a preferred software download app of an app download platform 50 (i.e., the action) to download the mobile app (e.g., without requiring the user 10 manually launch the software download app and search for the mobile app), followed by passing on the unique identifier to the processor 200 to perform a check if a redemption reward is available for the user 10 after the mobile app has been downloaded and installed in the user device 10 (as described above and in the present disclosure).

The processor 200 is also configurable or configured to perform a redemption process for users 10 who want to receive redemption rewards for products purchased, used, and/or otherwise received by the user 10. The redemption process may include receiving and processing, by the processor 200, a redemption request, or the like, from the user 10. Such redemption requests may be generated by a user device 10 pursuant to the user device 10 detecting a detectable identifier for the unit of the product purchased, used, and/or otherwise received by the user 10 (as described in the present disclosure). In detecting the detectable identifier, the user device 10 may be configurable or configured to extract and/or obtain the unique identifier of the information payload (i.e., the unique identifier for the particular unit of the product) from the detectable identifier (and/or an action or function that the detectible identifier causes the user device 10 to perform) and include the unique identifier in the redemption request. The redemption request is then sent by the user device 10 to the processor 200. Once the redemption request is received, the processor 200 is configurable or configured to perform a redemption verification process. As described in the present disclosure, the redemption verification process includes, but is not limited to, obtaining information about the user 10 (and/or user device 10). Such information about the user 10 may include, but is not limited to, one or more information provided by the user 10 during the configuration or setup process for the user 10 (e.g., name of the user 10 (e.g., legal name, first name, last name, middle name or initial, etc.), email address, social media handle or login (e.g., Facebook, Google, etc.), user name, electronic wallet information for receiving redemption rewards, or the like, etc.), geolocation of the user 10 or user device 10, current date/time stamp, transaction history of the user 10, redemption history of the user 10, and/or consumption history of the user 10. The redemption verification process may also include searching for and obtaining, such as via an information payload database 70, or the like, the specific unique information payload generated for the particular unit of the product purchased, used, and/or otherwise received by the user 10. Such searching may be based on the redemption request. For example, when the redemption request includes the unique identifier for the information payload (i.e., the unique identifier for the particular unit of the product), the search for the information payload may be performed based on the unique identifier. Once the information payload for the particular unit of the product has been obtained, the redemption verification process includes identifying, from the information payload, a redemption status for the particular unit of the product, that is, whether the redemption status is a redeemed status or an unredeemed status. The redemption verification process may also include identifying, from the information payload, geolocation eligibilities and/or restrictions for the particular unit of the product and comparing such geolocation eligibilities and/or restrictions to a geolocation of the user 10 or user device 10. The redemption verification process may also include identifying, from the information payload, temporal eligibilities and/or restrictions for the particular unit of the product and comparing such temporal eligibilities and/or restrictions to a current date/time stamp (or date/time stamp of or in the redemption request; or date/time stamp when the redemption request was received by the processor 200). The redemption verification process may also include identifying, from the information payload, a consumption status for the particular unit of the product, that is, whether the consumption status is a consumed status or an unconsumed status. The redemption verification process may also include identifying other information, either from the information payload or not, without departing from the teachings of the present disclosure. Responsive to a determination that the redemption status for the particular unit of the product is the unredeemed status (and geolocation of the user 10 is in an eligible geolocation and/or not in a restricted geolocation; and current date/time stamp is in an eligible date/time and/or not in a restricted or expired date/time; etc.), the redemption verification process includes identifying the redemption reward(s) available for the particular unit of the product and transferring such redemption reward(s) to an electronic wallet of the user 10. In example embodiments where the redemption rewards are in the form of a digital asset (e.g., digital token, digital coupon, digital badge, cryptocurrency, etc.), the redemption verification process may include recording, in a distributed ledger (e.g., blockchain, or the like), a transfer of such digital asset to the electronic wallet of the user 10.

The processor 200 is also configurable or configured to perform a consumption process for users 10 who want to consume redemption rewards redeemed by the user 10. The consumption process may include receiving and processing, by the processor 200, a consumption request, or the like, from the user 10. Such consumption requests may be generated by a user device 10 when a user 10 desires to consume the redeemed redemption reward (as stored in the user's electronic wallet). The user device 10 may be configurable or configured to extract and/or obtain a unique identifier of the information payload (i.e., the unique identifier for the particular unit of the product that the user 10 purchased, used, and/or otherwise received in order to receive the redemption reward) from the redeemed redemption reward and include the unique identifier in the consumption request. The consumption request is then sent by the user device 10 to the processor 200. Once the consumption request is received, the processor 200 is configurable or configured to perform a consumption verification process. As described in the present disclosure, the consumption verification process includes, but is not limited to, obtaining information about the user 10 (and/or user device 10). Such information about the user 10 may include, but is not limited to, one or more information provided by the user 10 during the configuration or setup process for the user 10 (e.g., name of the user 10 (e.g., legal name, first name, last name, middle name or initial, etc.), email address, social media handle or login (e.g., Facebook, Google, etc.), user name, electronic wallet information for receiving redemption rewards, or the like, etc.), geolocation of the user 10 or user device 10, current date/time stamp, transaction history of the user 10, redemption history of the user 10, and/or consumption history of the user 10. The consumption verification process may also include searching for and obtaining, such as via an information payload database 70, or the like, the specific unique information payload generated for the particular unit of the product that the user 10 purchased, used, and/or otherwise received in order to receive the redemption reward. Such searching may be based on the consumption request. For example, when the consumption request includes the unique identifier for the information payload (i.e., the unique identifier for the particular unit of the product), the search for the information payload may be performed based on the unique identifier. Once the information payload for the particular unit of the product has been obtained, the consumption verification process includes identifying, from the information payload, a consumption status for the particular unit of the product, that is, whether the consumption status is a consumed status or an unconsumed status. The consumption verification process may also include identifying, from the information payload, geolocation eligibilities and/or restrictions for the particular unit of the product and comparing such geolocation eligibilities and/or restrictions to a geolocation of the user 10 or user device 10. The consumption verification process may also include identifying, from the information payload, temporal eligibilities and/or restrictions for the particular unit of the product and comparing such temporal eligibilities and/or restrictions to a current date/time stamp (or date/time stamp of or in the redemption request; or date/time stamp when the redemption request was received by the processor 200). The consumption verification process may also include identifying other information, either from the information payload or not, without departing from the teachings of the present disclosure. Responsive to a determination that the consumption status for the particular unit of the product is the unconsumed status (and geolocation of the user 10 is in an eligible geolocation and/or not in a restricted geolocation; and current date/time stamp is in an eligible date/time and/or not in a restricted or expired date/time; etc.), the consumption verification process includes removing the redemption reward from the electronic wallet of the user 10. Such removal of the redemption reward from the electronic wallet of the user 10 may include transferring such redemption reward from the electronic wallet of the user 10 (e.g., to an electronic wallet of the merchant 20 and/or intermediary 30; to a “spent” electronic wallet; to be destroyed or terminated; etc.). In example embodiments where the redemption rewards are in the form of a digital asset (e.g., digital token, digital coupon, digital badge, cryptocurrency, etc.), the consumption verification process may include recording, in a distributed ledger (e.g., blockchain, or the like), a transfer of such digital asset from the electronic wallet of the user 10. The consumption verification process may also include sending one or more notifications of the consumption of the redemption reward, including, but not limited to, a notification to the merchant 20 or intermediary 30 who is providing the reward to the user 10 in exchange for the redeemed redemption reward; a notification to the user 10 to inform the user 10 that the consumption request has been approved/completed; and/or a notification to the original merchant 10 or intermediary whose product (and/or service) the user 10 purchased, used, and/or otherwise received in order to receive the redemption reward. For example, if the user 10 purchased a box of cereal (i.e., the product), received a QR code (i.e., detectable identifier), scanned (i.e., detect) the QR code with the user's mobile device 10, redeemed a redemption reward, collected enough redemption rewards to redeem for a free box of cereal (e.g., collected 6 digital stamps), and wanted to consume the 6 digital stamps for the free box of cereal, the user 10 may visit a participating supermarket 20, 30 (e.g., merchant 20 or intermediary 30) and submit a consumption request (e.g., launching a mobile app, selecting the redemption reward to consume, and sending a consumption request to the processor 200). Alternatively or in addition, the user 10 may not necessarily need to visit a participating supermarket 20, 30, but instead do so virtually such as via a website or mobile app of the supermarket 20, 30. Upon receiving the consumption request, the processor 200 will then perform a consumption verification process. If the consumption verification process performed by the processor 200 does not encounter any issues (e.g., redemption reward has not yet been consumed, there are no geolocation restrictions or issues, there are no temporal restriction or issues, etc.), the processor 200 may proceed to consume the redemption reward, including remove the redemption reward from the electronic wallet of the user 10. The processor 200 may also send a notification to the supermarket 20, 30 to notify, inform, and/or otherwise confirm that the user 10 has consumed the redemption reward for a free box of cereal. The processor 200 may also send a notification to the user 10 and/or cereal manufacturer 20.

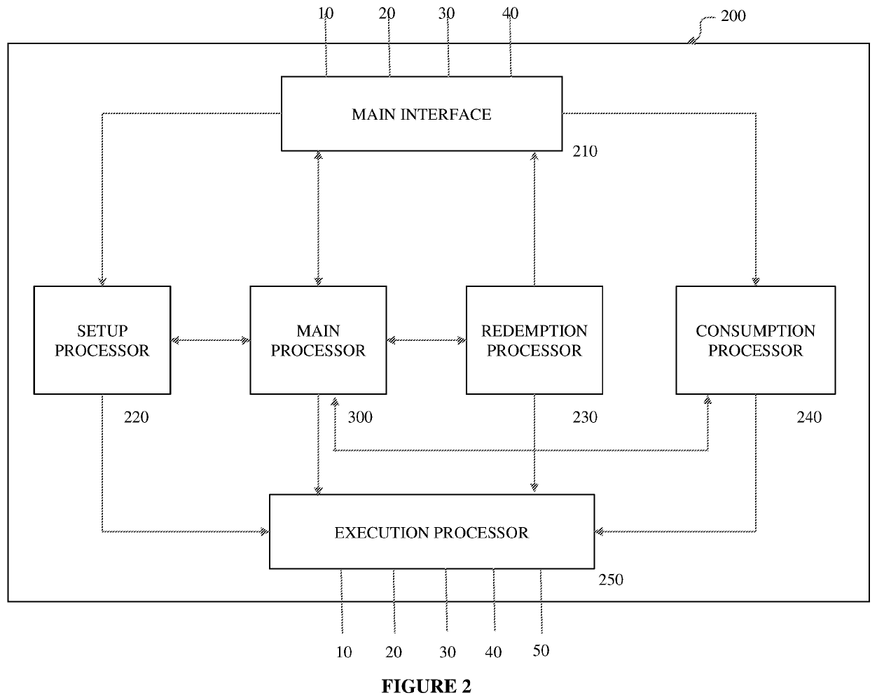

To perform the processes and/or methods described above and in the present disclosure, example embodiments of the processor 200 include one or more elements. For example, as illustrated in FIG. 2, the processor 200 includes one or more main interfaces 210. The processor 200 also includes one or more setup processors 220. The processor 200 also includes one or more redemption processors 230. The processor 200 also includes one or more consumption processors 240. The processor 200 also includes one or more main processors 300. Although the figures illustrate one main interface 210, one setup processor 220, one redemption processor 230, one consumption processor 240, and one main processor 300, it is to be understood in the present disclosure that the processor 200 may include more or less than one main interface 210, more or less than one setup processor 220, more or less than one redemption processor 230, more or less than one consumption processor 240, and more or less than one main processor 300 without departing from the teachings of the present disclosure. It is also to be understood in the present disclosure that, although the functions and/or processes performed by the processor 200 are described in the present disclosure as being performed by particular elements of the processor 200, the functions and/or processes performed by a particular element of the processor 200 may also be performed by one or more other elements and/or cooperatively performed by more than one element of the processor 200 without departing from the teachings of the present disclosure. It is also to be understood that, although the functions and/or processes performed by the processor 200 are described in the present disclosure as being performed by particular elements of the processor 200, the functions and/or processes performed by two or more particular elements of the processor 200 may be combined and performed by one element of the processor 200 without departing from the teachings of the present disclosure.

These elements of the processor 200 will now be further described with reference to the accompanying figures.

The Main Interface (e.g., Main Interface 210).

As illustrated in FIG. 2, an example embodiment of the processor 200 includes one or more main interfaces (e.g., main interface 210). The main interface 210 is configurable or configured to act as a communication interface for the processor 200. For example, the main interface 210 is configurable or configured to receive configuration or setup requests from merchants 20 and/or intermediaries 30 (e.g., requests to generate information payloads and detectable identifiers for one or more units of one or more products). The main interface 210 is also configurable or configured to receive redemption requests from users 10 (e.g., requests to redeem or receive a redemption reward for a product and/or service purchased, used, and/or otherwise received by the user 10). The main interface 210 is also configurable or configured to receive consumption requests from users 10 (e.g., requests to consume redemption rewards that have been redeemed by the user 10). The main interface 210 is also configurable or configured to communicate with one or more databases 70 and/or distributed ledgers 70. The main interface 210 is also configurable or configured to communicate with one or more other elements of the processor 200 and/or other processors 200. The main interface 210 (and/or the execution processor 250) is also configurable or configured to transfer redemption rewards (and/or cooperate and/or facilitate the transfer of redemption rewards). The main interface 210 is also configurable or configured to consume redeemed redemption rewards (and/or cooperate and/or facilitate the consumption of redemption rewards). The main interface 210 is also configurable or configured to send notifications, including those to merchants 20, intermediaries, 30, and/or users 10, and exchange information with users 10, merchants 20, intermediaries 30, detectable identifier manufacturers 40, app download platforms 50, the network 60, and/or databases 70 and/or distributed ledgers 70.

After the main interface 210 receives any of the above information, the main interface 210 is configurable or configured to selectively provide such information to one or more other elements of the processor 200 and/or other processors 200 for further processing, including providing configuration or setup requests and information for performing a configuration or setup process to the setup processor 220 and/or the main processor 300; providing redemption requests and information for performing a redemption process to the redemption processor 230 and/or the main processor 300; providing consumption requests and information for performing a consumption process to the consumption processor 240 and/or the main processor 300; and providing information necessary for the execution processor 250 to execute one or more results of the setup processor 220, redemption processor 230, consumption processor 240, and/or main processor 300.

The Setup Processor (e.g., Setup Processor 220).

As illustrated in FIG. 2, an example embodiment of the processor 200 includes one or more setup processors (e.g., setup processors 220). The setup processor 220 is configurable or configured to receive configuration or setup requests from a plurality of merchants 20 and/or intermediaries 30 (e.g., via the main interface 201). In this regard, merchant devices 20 and/or intermediary devices 20 may be configurable or configured to generate configuration or setup requests and transmit such configuration or setup requests to the main interface 201. Once the setup processor 220 receives a configuration or setup request for one or more units of a product, the setup processor 220 is configurable or configured to generate a unique information payload for each unit of the product. The setup processor 220 is then configurable to generate a unique detectable identifier for each unit of the product, and each such unique detectable identifier is associated with and/or corresponds to a unique information payload.

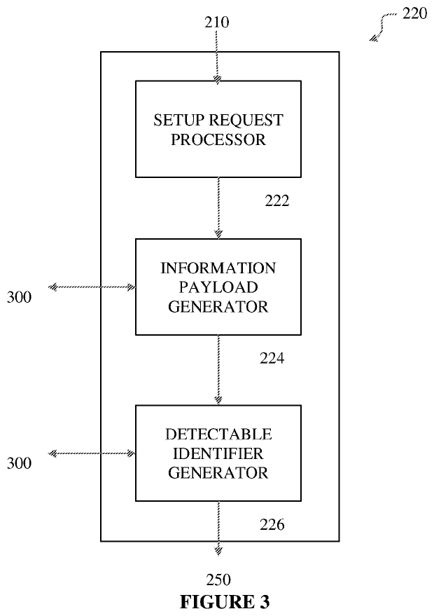

To perform these processes and/or methods, example embodiments of the setup processor 220 include one or more elements. For example, as illustrated in FIG. 3, the setup processor 220 includes one or more setup request processors 222. The setup processor 220 also includes one or more information payload generators 224. The setup processor 220 also includes one or more detectable identifier generators 226. Although the figures may illustrate one setup request processor 222, one information payload generator 224, and one detectable identifier generator 226, it is to be understood in the present disclosure that the setup processor 220 may include more or less than one setup request processor 222, more or less than one information payload generator 224, and more or less than one detectable identifier generator 226 without departing from the teachings of the present disclosure. It is also to be understood in the present disclosure that, although the functions and/or processes performed by the setup processor 220 are described in the present disclosure as being performed by particular elements of the setup processor 220, the functions and/or processes performed by a particular element of the setup processor 220 may also be performed by one or more other elements and/or cooperatively performed by more than one element of the processor 200 without departing from the teachings of the present disclosure. It is also to be understood that, although the functions and/or processes performed by the setup processor 220 are described in the present disclosure as being performed by particular elements of the setup processor 220, the functions and/or processes performed by two or more particular elements of the setup processor 220 may be combined and performed by one element of the processor 200 without departing from the teachings of the present disclosure.

These elements of the setup processor 220 will now be further described with reference to the accompanying figures.

The Setup Request Processor (e.g., Setup Request Processor 222).

As illustrated in FIG. 3, an example embodiment of the setup processor 220 includes one or more setup request processors (e.g., setup request processors 222). The setup request processor 222 is configurable or configured to process configuration or setup requests received from a plurality of merchants 20 and/or intermediaries 30 (e.g., via the main interface 201).

In an example embodiment, the setup request processor 222 is configurable or configured to categorize the information provided in each configuration or setup request. Example categories include, but are not limited to, a product category (e.g., information pertaining to the product that will participate in the reward redemption, such as the brand, product name, product description, product model number, unique product identifier, etc.); quantity category (e.g., information pertaining to the quantity of units of the product that will participate in the reward redemption); redemption reward category (e.g., information pertaining to the redemption reward to be provided, which may include a redemption reward metric, or the like, such as a list of possible/available redemption rewards, criteria or criterion for redeeming each redemption reward, etc.); geolocation category (e.g., information pertaining to geolocation eligibilities and/or restrictions); temporal category (e.g., information pertaining to temporal eligibilities and/or restrictions); redemption status category (e.g., merchant 20 and/or intermediary 30 preferences, if any, on the redemption status); consumption status category (e.g., merchant 20 and/or intermediary 30 preferences, if any, on the consumption status); user category (e.g., information pertaining to user eligibility and/or restrictions); merchant category (e.g., information pertaining to the merchant 20 or intermediary 30); gamification category (e.g., information pertaining to any gamification for redeeming rewards); etc. After the setup request processor 222 performs the categorizing of the information found in each configuration or setup request, the categorized information is provided to the information payload generator 224 and/or the detectable identifier generator 226 for further processing.

The Information Payload Generator (e.g., Information Payload Generator 224).

As illustrated in FIG. 3, an example embodiment of the setup processor 220 includes one or more information payload generators (e.g., information payload generator 224). The information payload generator 224 is configurable or configured to receive categorized information from the setup request processor 222.

Once the information payload generator 224 receives the categorized information, the information payload generator 224 is configurable or configured to generate a unique information payload for each of the units of the product. In generating each unique information payload, the information payload generator 224 cooperates with the unique identifier processor 305 of the main processor 300 to generate a unique identifier for each unique information payload. Each generated information payload may include other information pertaining to one or more of the received categorized information.

In an example embodiment, each generated information payload includes one or more redemption rewards that will be redeemable by the user 10 who purchases the particular unit of the product that is associated with the generated information payload. The information payload generator 224 cooperates with the reward processor 310 of the main processor 330 to obtain the redemption rewards for each information payload, and does so by providing information it has received, including information that has been categorized in the redemption reward category. The reward processor 310 then selects one or more redemption rewards for each unique information payload, and provides it back to the information payload generator 224 for including in each unique information payload. Although typical embodiments may provide for the redemption reward for each unit of a product to be the same (e.g., same redemption reward of 1 digital stamp is redeemable for each of the 2,000 bottles of soda, and when the user 10 collects 8 digital stamps then the user 10 can trade/consume the 8 digital stamps for a free bottle of soda), the redemption reward may also vary for one, some or all units of a product without departing from the teachings of the present disclosure. For example, users 10 who purchase one or some particular units of a product may redeem for a much larger or more valuable redemption reward (e.g., 3 of the 2,000 bottles have a redemption reward being a free Nintendo Switch console), which enables users 10 to participate in trying to purchase the lucky unit of the product.

In an example embodiment, each generated information payload includes one or more temporal eligibilities and/or restrictions for the redeeming and/or consuming of the redemption rewards. The information payload processor 224 cooperates with the temporal processor 315 of the main processor 330 to obtain the temporal eligibility and/or restriction for each information payload, and does so by providing information it has received, including information that has been categorized in the temporal category. The temporal processor 315 then selects temporal eligibilities (e.g., redeemable only during this particular period of time; consumable only within a certain period of time after redeeming; etc.) and/or restrictions (not redeemable during this particular period of time; not consumable during this particular period of time) for each unique information payload, and provides it back to the information payload generator 224 for including in each unique information payload. Although typical embodiments may provide for the temporal eligibilities and/or restrictions for each unit of a product to be the same (e.g., same expiry date to redeem and/or consume each of the 2,000 bottles of soda), the temporal eligibilities and/or restrictions may also vary for one, some or all units of a product (and/or there may be more than one temporal eligibility and/or restriction for one, some or all units of a product) without departing from the teachings of the present disclosure. For example, in a situation where one or some particular units of a product may redeem for a much larger or more valuable redemption reward (e.g., 3 of the 2,000 bottles have a redemption reward being a free Nintendo Switch console), the temporal eligibilities and/or restrictions of the majority of units of the product that are redeemable for the normal redemption reward may have a standard temporal eligibility and/or restriction (e.g., redemption expiry date of 1 year; consumption expiry date of 3 months from redemption) and the temporal eligibilities and/or restrictions of the particular units of the product redeemable for the much larger or more valuable redemption reward may have a first special temporal eligibility and/or restriction (e.g., expiry date of 6 months in which to redeem for the larger or more valuable redemption reward, after which time the redemption reward becomes the normal redemption reward; expiry date of 1 month in which to consume the larger or more valuable redemption reward, after which time the redemption reward is no longer consumable) followed by a second special temporal eligibility and/or restriction (e.g., expiry date of 1 year in which to redeem for the normal redemption reward).

In an example embodiment, each generated information payload includes one or more geolocation eligibilities and/or restrictions for the redeeming and/or consuming of the redemption rewards. The information payload processor 224 cooperates with the geolocation processor 320 of the main processor 330 to obtain the geolocation eligibility and/or restriction for each information payload, and does so by providing information it has received, including information that has been categorized in the geolocation category. The geolocation processor 330 then selects one or more geolocation eligibilities (e.g., redeemable only in one or more particular locations; consumable only in one or more particular locations; and locations may be certain areas in a city, a particular city, particular state/province, particular country, particular region, particular continent, etc.) and/or restrictions (e.g., not redeemable in one or more particular locations; not consumable in one or more particular locations (or not consumable at one or more non-participating merchants 20 and/or intermediaries 30)) for each unique information payload, and provides it back to the information payload generator 224 for including in each unique information payload. Although typical embodiments may provide for the geolocation eligibilities and/or restrictions for each unit of a product to be the same (e.g., same geolocation eligibilities and restrictions for each of the 5,000 packages of coffee filters), the geolocation eligibilities and/or restrictions may also vary for one, some or all units of a product (and/or there may be more than one geolocation eligibility and/or restriction for one, some or all units of a product) without departing from the teachings of the present disclosure. For example, in a situation where one or some particular units of a product may redeem for a much larger or more valuable redemption reward (e.g., 100 of the 5,000 packages of coffee filters have a redemption reward being a coffee machine with 220V), the geolocation eligibilities and/or restrictions of the majority of units of the product that are redeemable for the normal redemption reward may have a standard geolocation eligibility and/or restriction (e.g., anywhere in the world) and the geolocation eligibilities and/or restrictions of the particular units of the product redeemable for the much larger or more valuable redemption reward may have a first special geolocation eligibility and/or restriction (e.g., only in Asia to redeem for the larger or more valuable redemption reward, after which time the redemption reward becomes the normal redemption reward) followed by a second special eligibility and/or restriction (e.g., anywhere in the world).

In an example embodiment, each generated information payload includes a redemption status, which represents a status of whether or not a redemption reward for a particular unit of the product (which is associated with the information payload) has been redeemed. The information payload processor 224 cooperates with the redemption status processor 325 of the main processor 330 to obtain the redemption status options that will be used for each information payload, and does so by providing information it has received, including information that has been categorized in the redemption status category. The redemption status processor 325 then selects one or more redemption status options for each unique information payload, and provides it back to the information payload generator 224 for including in each unique information payload. Although typical embodiments may provide for the redemption status options for each unit of a product to be the “redeemed status” and “unredeemed status”, the redemption status options may also include other statuses and/or vary for one, some or all units of a product (e.g., redemption rewards for all units of the product may be redeemable more than once and/or by more than one user 10; one or some particular units of the product may be redeemable more than once and/or by more than one user 10; one or more additional and/or alternative statuses, such as “redeemed but still redeemable”, “redeemed but still redeemable X times”, “redeemed but other redemption reward(s) available”, “redemption transferrable to another user 10”, etc.) without departing from the teachings of the present disclosure. For example, a merchant 20 and/or intermediary 30 may desire for one or some particular units of a product to be redeemable in one or more of the following ways, one or more of which may be generated and provided by the redemption status processor 325 to the information payload processor 224: only once by only one user 10; more than once by the same user 10 (but not by other users 10); more than once by different users 10 (but each user 10 can only redeem once); more than once but only at different geolocations; more than once but only at the same geolocation; more than once but only on different dates; more than once but only based on a history of the user 10 (e.g., only loyal users 10 and/or users 10 who have achieved a certain status); redemption status resets periodically (e.g., every day, week, month, year, etc.); more than once but only to users 10 who are socially linked to the user 10 who first redeemed the redemption reward for the particular unit of the product; more than once but only to users 10 who are not socially linked to the user who first redeemed the redemption reward for the particular unit of the product; etc.

In an example embodiment, each generated information payload includes a consumption status, which represents a status of whether or not a redemption reward for a particular unit of the product (which is associated with the information payload) has been consumed. The information payload processor 224 cooperates with the consumption status processor 330 of the main processor 330 to obtain the consumption status options that will be used for each information payload, and does so by providing information it has received, including information that has been categorized in the consumption status category. The consumption status processor 330 then selects one or more consumption status options for each unique information payload, and provides it back to the information payload generator 224 for including in each unique information payload. Although typical embodiments may provide for the consumption status options for each unit of a product to be the “consumed status” and “unconsumed status”, the consumption status options may also include other statuses and/or vary for one, some or all units of a product (e.g., redemption rewards for all units of the product may be consumable more than once and/or by more than one user 10; one or some particular units of the product may be consumable more than once and/or by more than one user 10) without departing from the teachings of the present disclosure. For example, a merchant 20 and/or intermediary 30 may desire for one or some particular units of a product to be consumable in one or more of the following ways, one or more of which may be generated and provided by the consumption status processor 330 to the information payload processor 224: only once by only one user 10; more than once by the same user 10 (but not by other users 10; one or more additional and/or alternative statuses, such as “consumed but still consumable”, “consumed but still consumable X times”, “consumed but other redemption reward(s) available”, “consumption transferrable to another user 10”, etc.); more than once by different users 10 (but each user 10 can only consume once); more than once but only at different geolocations; more than once but only at the same geolocation; more than once but only on different dates; more than once but only based on a history of the user 10 (e.g., only loyal users 10 and/or users 10 who have achieved a certain status); consumption status resets periodically (e.g., every day, week, month, year, etc.); more than once but only to users 10 who are socially linked to the user 10 who first redeemed and/or consumed the redemption reward for the particular unit of the product; more than once but only to users 10 who are not socially linked to the user who first redeemed and/or consumed the redemption reward for the particular unit of the product; etc.

In an example embodiment, each generated information payload includes a gamification aspects for users 10 to play before redeeming and/or consuming a redemption reward. The information payload processor 224 cooperates with the gamification processor 335 of the main processor 330 to obtain the game options that will be used for each information payload, and does so by providing information it has received, including information that has been categorized in the gamification category. The gamification processor 335 then selects one or more gamification options for each unique information payload, and provides it back to the information payload generator 224 for including in each unique information payload. Example gamification options include, but are not limited to, a trivia quiz, a math quiz, questions regarding the product of the merchant 20 and/or intermediary 30, spin a wheel, lucky draw, etc.

In an example embodiment, each generated information payload includes information regarding the product that the user 10 purchased, used, and/or otherwise received in order to be eligible to redeem the redemption rewards. The information payload generator 224 cooperates with the product information processor 340 of the main processor 330 to obtain the product information for each information payload, and does so by providing information it has received, including information that has been categorized in the product information category. The product information processor 310 then selects the product information for each unique information payload, and provides it back to the information payload generator 224 for including in each unique information payload. Product information for inclusion in each unique information payload may include, but are not limited to, information pertaining to the product that will participate in the reward redemption, such as the brand, product name, product description, product type, product origin, product model number, unique product identifier, etc.

In an example embodiment, each generated information payload includes information regarding the merchant 20 and/or intermediary 30 who provided the product that the user 10 purchased, used, and/or otherwise received in order to be eligible to redeem the redemption rewards. The information payload generator 224 cooperates with the merchant information processor 345 of the main processor 330 to obtain the merchant 20 and/or intermediary 30 information for each information payload, and does so by providing information it has received, including information that has been categorized in the merchant information category. The merchant information processor 345 then selects the merchant 20 and/or intermediary 30 information for each unique information payload, and provides it back to the information payload generator 224 for including in each unique information payload. Merchant 20 and/or intermediary 30 information for inclusion in each unique information payload may include, but are not limited to, merchant name, merchant 20 and/or intermediary 30 location(s)/address(es), merchant 20 and/or intermediary 30 product and/or service coverage, merchant 20 and/or intermediary 30 products and/or product types offering redemption rewards, merchant 20 and/or intermediary 30 history, unique merchant identifier or unique intermediary identifier, etc.

In an example embodiment, each generated information payload includes or will include information regarding the user 10 who submits a redemption request (as described in the present disclosure), and such user 10 will be a user who has purchased, used, and/or otherwise received a unit of a product that is eligible to redeem the redemption rewards. In some embodiments, the information regarding the user 10 may also include any specific user eligibility and/or restrictions desired by the merchant 20 and/or intermediary 30 (e.g., not eligible for employees of the merchant 20 and/or intermediary 30, etc.). The information payload generator 224 cooperates with the user information processor 350 of the main processor 330 to obtain the user 10 information, eligibilities and/or restrictions for each information payload, and does so by providing information it has received, including information that has been categorized in the user information category. The user information processor 350 then selects the user 10 information for each unique information payload, and provides it back to the information payload generator 224 for including in each unique information payload. User 10 information for inclusion in each unique information payload may include, but are not limited to, user 10 name, user 10 location(s)/address(es) (e.g., residential address, work address, etc.), user 10 preferences, user 10 interests, user 10 purchase history, user 10 redemption history, user 10 consumption history, unique user identifier, user 10 eligibilities, user 10 restrictions, etc.

In an example embodiment, each generated information payload may include detectable identifier information pertaining to the detectable identifier that has or will be generated for the particular unit of the product that is associated with the information payload (i.e., associated with the redemption rewards). The information payload generator 224 may cooperate with the detectable identifier generator 226 and/or the detectable identifier processor 360 and the action generator 355 of the main processor 330 to obtain and/or generate the detectable identifier information for each information payload. Detectable identifier information may include, but is not limited to, one or more detectable identifiers, one or more commands, and one or more actions. As described in the present disclosure, detectable identifiers may include, but are not limited to, QR codes, barcodes, NFC tags, RFID tags, specific images or graphics detectable by an image capturing device of or associated with a user device 10, specific sequences of characters, and/or any other device, object, article, tag, signal, image, graphic, geolocation, series and/or sequence of characters, and/or a combination of any one or more of the foregoing that may be configurable or configured to be detectable (e.g., scannable, receivable, identifiable, etc.) by user devices 10 so as to perform one or more actions. As described in the present disclosure, each detectable identifier includes and/or is associated with one or more commands. Commands are configurable or configured so as to be read by a user device 10 upon detecting of the detectable identifier. Once read, the commands are configurable or configured to cause and/or request the user device 10 to perform one or more actions. Commands may include, but are not limited to, instructions, functions, function calls, links, hyperlinks, procedures, procedure calls, scripts, etc. As described in the present disclosure, the one or more actions are performable or performed by a user device 10 pursuant to the user device 10 reading the one or more commands. The one or more actions may include, but are not limited to, generating a redemption request, obtaining and/or including/passing certain information into the redemption request, and/or sending and/or transmitting the redemption request from the user device 10 to the processor 200.

The Detectable Identifier Generator (e.g., Detectable Identifier Generator 226).

As illustrated in FIG. 3, an example embodiment of the setup processor 220 includes one or more detectable identifier generators (e.g., detectable identifier generator 226). The detectable identifier generator 226 is configurable or configured to receive categorized information from the setup request processor 222, including, but not limited to, the types or forms of detectable identifiers preferred/selected by the merchant 20 and/or intermediary 30, one or more commands to be associated with the detectable identifier(s), and/or one or more actions to be performed by a user device 10 upon detecting the detectable identifier.

Once the detectable identifier generator 226 receives the categorized information pursuant to a configuration or setup request, the detectable identifier generator 226 is configurable or configured to generate a unique detectable identifier for each of the units of the product. The detectable identifier generator 226 cooperates with the detectable identifier processor 360 and the action generator 355 of the main processor 330 to generate the detectable identifier information for each information payload. The detectable identifier generator 226 does so by providing information it has received, including information that has been categorized in the detectable identifier category and the action category. The detectable identifier processor 360 then generates a detectable identifier that is unique for each unique information payload (e.g., each unit of the product (and each information payload) has a unique detectable identifier). As described in the present disclosure, detectable identifiers may include, but are not limited to, QR codes, barcodes, NFC tags, RFID tags, specific images or graphics detectable by an image capturing device of or associated with a user device 10, specific sequences of characters, and/or any other device, object, article, tag, signal, image, graphic, geolocation, series and/or sequence of characters, and/or a combination of any one or more of the foregoing that may be configurable or configured to be detectable (e.g., scannable, receivable, identifiable, readable, etc.) by user devices 10 so as to perform one or more actions.

The detectable identifier processor 360 is then configurable or configured to generate one or more commands, instructions, functions, function calls, links, hyperlinks, procedures, procedure calls, scripts, or the like, (each referred to herein as a “command”, or the like) for each detectable identifier. The one or more commands are configured in such a way that, when it is read by a user device 10 upon detecting a detectable identifier, the one or more commands cause and/or request the user device 10 to perform one or more actions, operations, processes, or the like, (each referred to herein as an “action”, or the like). The one or more commands (commands for the user device 10 to perform such one or more actions) are then provided back, along with the detectable identifier, to the detectable identifier generator 226. As described above and in the present disclosure, the detectable identifier and one or more commands may also be provided to the information payload generator 224 for including in each unique information payload. The one or more commands may include, but are not limited to, instructions, functions, function calls, links, hyperlinks, procedures, procedure calls, scripts, etc. The one or more actions performable or performed by a user device 10 pursuant to reading the one or more commands may include, but are not limited to, generating a redemption request, obtaining and including/passing certain information into the redemption request, and/or sending and/or transmitting the redemption request from the user device 10 to the processor 200. For example, for a unit of a product purchased by a user 10 having a detectable identifier attached to it, the one or more actions may include requesting and/or causing a user device 10 to obtain a unique identifier from the detectable identifier, obtaining certain information regarding the user (e.g., user name, etc.), and passing the unique identifier and the user information back to the processor 200. As a more specific example, a detectable identifier in the form of a unique QR code may be printed by a merchant 20 (or a detectable identifier manufacturer 40) on a sticker and attached to a unit of a product. The QR code (i.e., the detectable identifier) includes a command, such as a deep link URL and a unique identifier for the unit of the product. In such an example, when the QR code is scanned (i.e., detected) by a camera of a user device 10, the command requests and/or causes the user device 10 to: obtain the unique identifier from the QR code (i.e., the action); perform a check to see if the user device 10 already has a dedicated mobile app installed (e.g., as described above and in the present disclosure) (i.e., also part of the action); launch/open the dedicated mobile app when it has been determined that the dedicated mobile app has already been installed on the user device 10; and pass the unique identifier and/or other information (e.g., user information, current date/time, current geolocation, etc.) (i.e., also part of the action) back to the processor 200. Once the information is received by the processor 200 (which will be in the form of a redemption request), the processor 200 then performs, among other things, a redemption process (i.e., an assessment that includes first determining whether a redemption reward is redeemable by the user 10). In situations where it has been determined that the user device 10 has not yet installed such a dedicated mobile app, the command may request and/or cause the user device 10 to: launch/open (i.e., the action) a download page for the dedicated mobile app on a preferred software download app of an app download platform 50 (e.g., Apple App Store, Google Play Store, etc.) (i.e., also part of the action) to download the dedicated mobile app (and/or display information and/or instructions on the user device 10 to manually launch the software download app and/or search for and/or download the dedicated mobile app); and pass the unique identifier and/or other information (e.g., user information, current date/time, current geolocation, etc.) (i.e., also part of the action) back to the processor 200 (e.g., after installing the mobile app, passing such information to the installed mobile app to pass onto the processor 200). The processor 200 then performs, among other things, an assessment to determine whether a redemption reward is redeemable by the user 10.

After the detectable identifier (and the one or more commands and corresponding one or more actions) is generated for a particular unit of a product, the detectable identifier generator 226, the detectable identifier processor 360, the information payload generator 224, and/or one or more other elements of the processor 200 are configurable or configured to provide the generated detectable identifier to the execution processor 250, and the execution processor 250 is configurable or configured to provide the generated detectable identifier to the merchant 20, intermediary 30, and/or one or more detectable identifier manufacturers 40 to manufacture (e.g., print, produce, manufacture, etc.) the actual detectable identifier for the unit of the product and/or attach to the unit of the product (each as applicable). In this regard, each detectable identifier may be configurable or configured to attach to (e.g., printed on product packaging, printed on a sticker that is attached to the product or product packaging, secured to the product or product packaging when in the form of an NFC tag or RFID tag, etc.), associate with, and/or otherwise provided along with each unit of the product so as to allow a user 10 who has purchased, used, and/or otherwise received the unit of the product to use his/her user device 10 to detect the detectable identifier.

It is to be understood in the present disclosure that a particular unit of a product may have more than one detectable identifier (e.g., to allow for more options for a user 10 to detect the detectable identifier; as gamification for a user 10 to select one detectable identifier from among more than one detectable identifiers, each of which is associated with a different redemption reward; etc.). For example, for 10,000 hats to be sold, each unit of the hat may have a unique QR code as a detectable identifier, a unique bar code as a detectable identifier, a unique NFC tag as a detectable identifier, a unique RFID tag as a detectable identifier, and a series or sequence of characters as a detectable identifier.

The Redemption Processor (e.g., Redemption Processor 230).

As illustrated in FIG. 2, an example embodiment of the processor 200 includes one or more redemption processors (e.g., redemption processors 230). The redemption processor 230 is configurable or configured to receive redemption requests from a plurality of users 10 (e.g., via the main interface 201). In this regard, user devices 10 may be configurable or configured to generate redemption requests and transmit such redemption requests to the main interface 201. Once the redemption processor 230 receives a redemption request, the redemption processor 230 is configurable or configured to process the redemption request, including performing a redemption verification process to determine whether or not one or more redemption rewards are redeemable by the user 10 and performing a redemption reward redemption to transfer the redemption reward to the user 10 (i.e., user device 10) when the redemption verification process has determined that one or more redemption rewards are redeemable by the user 10.

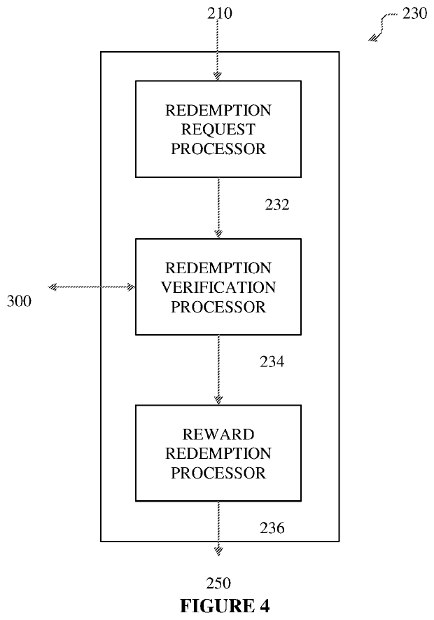

To perform these processes and/or methods, example embodiments of the redemption processor 230 include one or more elements. For example, as illustrated in FIG. 4, the redemption processor 230 includes one or more redemption request processors 232. The redemption processor 230 also includes one or more redemption verification processors 234. The redemption processor 230 also includes one or more reward redemption processors 236. Although the figures may illustrate one redemption request processor 232, one redemption verification processor 234, and one reward redemption processor 236, it is to be understood in the present disclosure that the redemption processor 230 may include more or less than one redemption request processor 232, more than one redemption verification processor 234, and more than one reward redemption processor 236 without departing from the teachings of the present disclosure. It is also to be understood in the present disclosure that, although the functions and/or processes performed by the redemption processor 230 are described in the present disclosure as being performed by particular elements of the redemption processor 230, the functions and/or processes performed by a particular element of the redemption processor 230 may also be performed by one or more other elements and/or cooperatively performed by more than one element of the processor 200 without departing from the teachings of the present disclosure. It is also to be understood that, although the functions and/or processes performed by the redemption processor 230 are described in the present disclosure as being performed by particular elements of the redemption processor 230, the functions and/or processes performed by two or more particular elements of the redemption processor 230 may be combined and performed by one element of the processor 200 without departing from the teachings of the present disclosure.

These elements of the redemption processor 230 will now be further described with reference to the accompanying figures.

The Redemption Request Processor (e.g., Redemption Request Processor 232).

As illustrated in FIG. 4, an example embodiment of the redemption processor 230 includes one or more redemption request processors (e.g., redemption request processors 232). The redemption request processor 232 is configurable or configured to process redemption requests received from a plurality of users 10 (e.g., via the main interface 201).

In an example embodiment, the redemption request processor 232 is configurable or configured to categorize the information provided in each redemption request. Example categories include, but are not limited to, a unique identifier category (e.g., the unique identifier passed back from the user device 10 to the processor 200 as part of the redemption request), a temporal category (e.g., a date/time stamp when the redemption request was created by the user device 10, sent by the user device 10, or received by the processor 200), a geolocation category (e.g., a geolocation of the user device 10 when the user device 10 created and/or sent the redemption request), and/or a user category (e.g., information pertaining to the user 10, such as user name, user ID, etc.). Categories may also include a product category (e.g., information pertaining to the product having the detectable identifier, such as the brand, product name, product description, product model number, unique product identifier, etc.); merchant category (e.g., information pertaining to the merchant 20 or intermediary 30); gamification category (e.g., information pertaining to any gamification for redeeming rewards); etc. After the redemption request processor 232 performs the categorizing of the information found in each redemption request, the categorized information is provided to the redemption verification processor 234 and/or the reward redemption processor 236 for further processing.

The Redemption Verification Processor (e.g., Redemption Verification Processor 234).

As illustrated in FIG. 4, an example embodiment of the redemption processor 230 includes one or more redemption verification processors (e.g., redemption verification processor 234). The redemption verification processor 234 is configurable or configured to receive categorized information from the redemption request processor 232.

Once the redemption verification processor 234 receives the categorized information, the redemption verification processor 234 is configurable or configured to perform a redemption verification process for each redemption request. In performing the redemption verification process, the redemption verification processor 234 cooperates with the main processor 300 to determine, among other things, whether or not the redemption reward is still available to be redeemed; the user 10 who sent the redemption request is eligible to redeem the redemption reward; whether the redeeming of the redemption reward has expired, etc. (or “redemption requirements”, or the like), as further described below and in the present disclosure.

In an example embodiment, the redemption verification process performed by the redemption verification processor 234 includes, but is not limited to, obtaining the unique identifier from the categorized information obtained from the redemption request (i.e., the unique identifier passed back from the user device 10 to the processor 200 as part of the redemption request). The redemption verification processor 234 also obtains information about the user 10 (and/or user device 10) from the redemption request. The redemption verification processor 234 may also obtain more information regarding the user 10, such as via a search in a user database 70 (which may include user information obtained from the user 10 during the configuration or setup process and/or during subsequent user information updates made by the user 10 after the configuration or setup process). User information may include, but is not limited to, information provided by the user 10 during the configuration or setup process for the user 10 (e.g., name of the user 10 (e.g., legal name, first name, last name, middle name or initial, etc.), email address, social media handle or login (e.g., Facebook, Google, etc.), user name, electronic wallet information for receiving redemption rewards, or the like, etc.), transaction history of the user 10, redemption history of the user 10, and/or consumption history of the user 10. The redemption verification processor 234 may also obtain geolocation information of the user 10 or user device 10 from the categorized information obtained from the redemption request (e.g., a geolocation of the user device 10 when the user device 10 created and/or sent the redemption request). The redemption verification processor 234 may also obtain temporal information from the categorized information obtained from the redemption request (e.g., a date/time stamp when the redemption request was created by the user device 10, sent by the user device 10, or received by the processor 200). The redemption verification processor 234 may also search for and obtain, via an information payload database 70, the information payload corresponding to the unique identifier obtained from the redemption request (i.e., the information payload for the particular unit of the product purchased, used, and/or otherwise received by the user 10, which is also associated with the detectable identifier detected by the user device 10).

Once the information payload corresponding to the unique identifier has been obtained, the redemption verification processor 234 is configurable or configured to identify, from the information payload, the redemption status for the particular unit of the product (e.g., whether the redemption status is a redeemed status or an unredeemed status) (or “redemption status requirements”, or the like). If the redemption verification processor 234 determines that the redemption status is an unredeemed status, the redemption verification processor 234 then continues with the redemption verification process, as described below and in the present disclosure. If, however, the redemption verification processor 234 determines that the redemption status is a redeemed status, the redemption verification processor 234 notifies the reward redemption processor 236 that the user 10 is not eligible to redeem a redemption reward and cooperates with the execution processor 250 to notify the user 10 accordingly (or, in situations where the merchant 20 and/or intermediary 30 allows for multiple and/or alternative redemption rewards to be redeemable by the same user 10 and/or different users 10, the redemption verification processor 234 notifies the reward redemption processor 236, which cooperates with the execution processor 250 accordingly). Although example embodiments may provide for the redemption status options for each unit of a product to be the “redeemed status” and “unredeemed status”, the redemption status options may also include other statuses and/or vary for one, some or all units of a product without departing from the teachings of the present disclosure.

The redemption verification processor 234 may also be configurable or configured to identify, from the information payload, geolocation eligibilities and/or restrictions for the particular unit of the product (or “geolocation requirements”, or the like). The geolocation eligibilities and/or restrictions are then compared to the geolocation information obtained from the redemption request. If the redemption verification processor 234 determines that the geolocation information from the redemption request is acceptable (e.g., is within the geolocation eligibilities and/or is not within the geolocation restrictions), the redemption verification processor 234 then continues with the redemption verification process, as described below and in the present disclosure. If, however, the redemption verification processor 234 determines that the geolocation information from the redemption request is not acceptable (e.g., is not within the geolocation eligibilities and/or is within the geolocation restrictions), the redemption verification processor 234 notifies the reward redemption processor 236 that the user 10 is not eligible to redeem a redemption reward and cooperates with the execution processor 250 to notify the user 10 accordingly (or, in situations where the merchant 20 and/or intermediary 30 allows for alternative redemption rewards to be redeemable by users 10 that do not pass geolocation requirements, the redemption verification processor 234 notifies the reward redemption processor 236, which cooperates with the execution processor 250 accordingly). Although typical embodiments may provide for the geolocation eligibilities and/or restrictions for each unit of a product to be the same (e.g., same geolocation eligibilities and restrictions for each unit of a product), the geolocation eligibilities and/or restrictions may also vary for one, some or all units of a product (and/or there may be more than one geolocation eligibility and/or restriction for one, some or all units of a product) without departing from the teachings of the present disclosure.

The redemption verification processor 234 may also be configurable or configured to identify, from the information payload, temporal eligibilities and/or restrictions for the particular unit of the product (or “temporal requirements”, or the like). The temporal eligibilities and/or restrictions are then compared to the temporal information obtained from the redemption request. If the redemption verification processor 234 determines that the temporal information from the redemption request is acceptable (e.g., is within the temporal eligibilities and/or is not within the temporal restrictions), the redemption verification processor 234 then continues with the redemption verification process, as described below and in the present disclosure. If, however, the redemption verification processor 234 determines that the temporal information from the redemption request is not acceptable (e.g., is not within the temporal eligibilities and/or is within the temporal restrictions), the redemption verification processor 234 notifies the reward redemption processor 236 that the user 10 is not eligible to redeem a redemption reward and cooperates with the execution processor 250 to notify the user 10 accordingly (or, in situations where the merchant 20 and/or intermediary 30 allows for alternative redemption rewards to be redeemable by users 10 that do not pass temporal requirements, the redemption verification processor 234 notifies the reward redemption processor 236, which cooperates with the execution processor 250 accordingly). Although typical embodiments may provide for the temporal eligibilities and/or restrictions for each unit of a product to be the same (e.g., same expiry date for each unit of a product), the temporal eligibilities and/or restrictions may also vary for one, some or all units of a product (and/or there may be more than one temporal eligibility and/or restriction for one, some or all units of a product) without departing from the teachings of the present disclosure.

The redemption verification processor 234 may also be configurable or configured to identify, from the information payload, a consumption status for the particular unit of the product, that is, whether the consumption status is a consumed status or an unconsumed status (or “consumption status requirements”, or the like). Although a redemption reward cannot be consumed if the redemption reward has not been redeemed, this check may be a backup check in case the redemption status was not updated from an unredeemed status to a redeemed status. Although typical embodiments may provide for the consumption status options for each unit of a product to be the “consumed status” and “unconsumed status”, the consumption status options may also include other statuses and/or vary for one, some or all units of a product (e.g., redemption rewards for all units of the product may be consumable more than once and/or by more than one user 10; one or some particular units of the product may be consumable more than once and/or by more than one user 10) without departing from the teachings of the present disclosure.

The redemption verification processor 234 may also be configurable or configured to identify, from the information payload, user eligibility and/or restrictions for the particular unit of the product (or “user requirements”, or the like). The user eligibilities and/or restrictions are then compared to the user information obtained from the redemption request. If the redemption verification processor 234 determines that the user information from the redemption request is acceptable (e.g., is within the user eligibilities and/or is not within the user restrictions), the redemption verification processor 234 then continues with the redemption verification process, as described below and in the present disclosure. If, however, the redemption verification processor 234 determines that the user information from the redemption request is not acceptable (e.g., is not within the user eligibilities and/or is within the user restrictions), the redemption verification processor 234 notifies the reward redemption processor 236 that the user 10 is not eligible to redeem a redemption reward and cooperates with the execution processor 250 to notify the user 10 accordingly (or, in situations where the merchant 20 and/or intermediary 30 allows for alternative redemption rewards to be redeemable by users 10 that do not pass user requirements, the redemption verification processor 234 notifies the reward redemption processor 236, which cooperates with the execution processor 250 accordingly).

The redemption verification processor 234 may also be configurable or configured to identify, from the information payload, gamification requirements for the particular unit of the product (or “gamification requirements”, or the like). The gamification requirements are then compared to the gamification information obtained from the redemption request and/or another source (e.g., outcome of any games that the user 10 was required to play before a redemption request is sent to the processor 200, which may be sent in the redemption request and/or or obtainable from a gamification processor, or the like). If the redemption verification processor 234 determines that the gamification information from the redemption request is acceptable (e.g., gamification requirements are satisfied), the redemption verification processor 234 then continues with the redemption verification process, as described below and in the present disclosure. If, however, the redemption verification processor 234 determines that the gamification information from the redemption request is not acceptable (e.g., gamification requirements are not satisfied), the redemption verification processor 234 notifies the reward redemption processor 236 that the user 10 is not eligible to redeem a redemption reward and cooperates with the execution processor 250 to notify the user 10 accordingly (or, in situations where the merchant 20 and/or intermediary 30 allows for alternative redemption rewards to be redeemable by users 10 that do not pass gamification requirements, the redemption verification processor 234 notifies the reward redemption processor 236, which cooperates with the execution processor 250 accordingly).

After the redemption verification processor 234 verifies the redemption requirements (including the redemption status requirements, temporal requirements, geolocation requirements, user requirements, consumption status requirements, gamification requirements, etc.), the redemption verification processor 234 is configurable or configured to identify, from the information payload, the redemption reward(s) redeemable by the user 10 for the particular unit of the product. In example embodiments where the redemption rewards are in the form of a digital asset (e.g., digital token, digital coupon, digital badge, cryptocurrency, etc.), the redemption verification processor 234 is configurable or configured to identify an electronic wallet of the user 10 (e.g., from the user information obtained from the redemption request; from information obtainable from a user database 70; etc.) that will receive the redemption reward(s). The redemption verification processor 234 then provides, among other things, the redemption reward(s) and electronic wallet information of the user 10 to the reward redemption processor 236 for further processing. Alternatively, if the redemption rewards are not in the form of a digital asset (e.g., a simple message sent to the dedicated mobile app of the user 10, an email or SMS message sent to the user 10, information sent to the dedicated mobile app of the user 10 to render a graphical or textual representation of the redemption reward (e.g., in the form of a frequent collector card having sections for redemption rewards in the form of stamps to appear therein), etc.), the redemption verification processor 234 provides, among other things, the redemption reward(s) and information regarding the user 10 to the reward redemption processor 236 for further processing. Although typical embodiments may provide for the redemption reward for each unit of a product to be the same (e.g., same redemption reward of 1 digital stamp is redeemable for each unit of a product), the redemption reward may also vary for one, some or all units of a product without departing from the teachings of the present disclosure.

The Reward Redemption Processor (e.g., Reward Redemption Processor 236).

As illustrated in FIG. 4, an example embodiment of the redemption processor 230 includes one or more reward redemption processors (e.g., reward redemption processor 236). The reward redemption processor 236 is configurable or configured to receive information from the redemption request processor 232 and information from the redemption verification processor 234.

Once the reward redemption processor 236 receives the information, the reward redemption processor 236 is configurable or configured to process each redemption request. For those redemption request in which the redemption verification processor 234 determines that all redemption requirements are met, the reward redemption processor 236 cooperates with the main processor 300 and one or more databases, including the information set database 70, to update the information set for the particular unit of the product (e.g., update the redemption status from the unredeemed status to the redeemed status, etc.). The reward redemption processor 236 then cooperates with the execution processor 250 to transfer the redemption rewards to the user 10. The redemption rewards may be transferred to an electronic wallet of the user 10. In example embodiments where the redemption rewards are in the form of a digital asset (e.g., digital token, digital coupon, digital badge, cryptocurrency, etc.), the transferring of the redemption rewards may include recording, in a distributed ledger (e.g., blockchain, or the like), a transfer of such digital asset to the electronic wallet of the user 10.

For those redemption requests in which the redemption verification processor 234 determines that one or more of the redemption requirements are not met (e.g., the redemption reward has already been redeemed, the expiry date has already passed, the user 10 is in a non-eligible location, etc.), the reward redemption processor 236 is configurable or configured to cooperate with the main processor 300 and one or more databases, including the information set database 70, to update the information set for the particular unit of the product (e.g., failed attempts of redemption, date/time of the failed redemption request, user 10 who submitted the failed redemption request, etc.). The reward redemption processor 236 then cooperates with the execution processor 250 to notify the user 10 that the redemption request did not succeed.

The Consumption Processor (e.g., Consumption Processor 240).

As illustrated in FIG. 2, an example embodiment of the processor 200 includes one or more consumption processors (e.g., consumption processors 240). The consumption processor 240 is configurable or configured to receive consumption requests from a plurality of users 10 (e.g., via the main interface 201). In this regard, user devices 10 (and/or devices of merchants 20 and/or intermediaries 30 who receive a visit and/or request from a user 10 to consume a redeemed redemption reward) may be configurable or configured to generate consumption requests and transmit such consumption requests to the main interface 201. Once the consumption processor 240 receives a consumption request, the consumption processor 240 is configurable or configured to process the consumption request. The processing may include performing a consumption verification process to determine whether or not one or more consumption rewards are consumable by the user 10. The processing may also include performing a redemption reward consumption to transfer the redemption reward from the user 10 (e.g., transfer the redemption reward to the processor 200, merchant 20, and/or intermediary 30; or in example embodiments, destroy, invalidate, or the like, the redemption reward) when the consumption verification process has determined that one or more redemption rewards are consumable by the user 10.

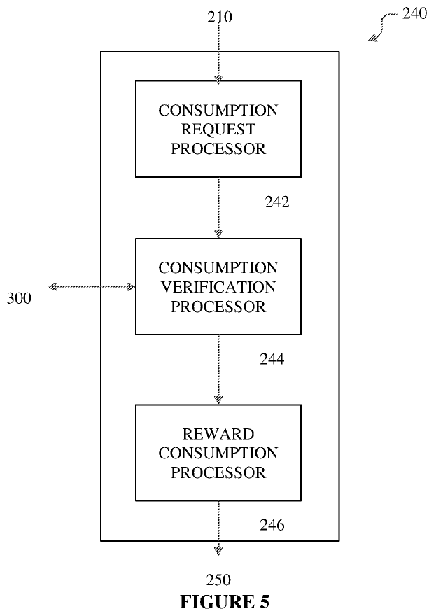

To perform these processes and/or methods, example embodiments of the consumption processor 240 include one or more elements. For example, as illustrated in FIG. 5, the consumption processor 240 includes one or more consumption request processors 242. The consumption processor 240 also includes one or more consumption verification processors 244. The consumption processor 240 also includes one or more reward consumption processors 246. Although the figures may illustrate one consumption request processor 242, one consumption verification processor 244, and one reward consumption processor 246, it is to be understood in the present disclosure that the consumption processor 240 may include more or less than one consumption request processor 242, more than one consumption verification processor 244, and more than one reward consumption processor 246 without departing from the teachings of the present disclosure. It is also to be understood in the present disclosure that, although the functions and/or processes performed by the consumption processor 240 are described in the present disclosure as being performed by particular elements of the consumption processor 240, the functions and/or processes performed by a particular element of the consumption processor 240 may also be performed by one or more other elements and/or cooperatively performed by more than one element of the processor 200 without departing from the teachings of the present disclosure. It is also to be understood that, although the functions and/or processes performed by the consumption processor 240 are described in the present disclosure as being performed by particular elements of the consumption processor 240, the functions and/or processes performed by two or more particular elements of the consumption processor 240 may be combined and performed by one element of the processor 200 without departing from the teachings of the present disclosure.

These elements of the consumption processor 240 will now be further described with reference to the accompanying figures.

The consumption request processor (e.g., consumption request processor 242).

As illustrated in FIG. 5, an example embodiment of the consumption processor 240 includes one or more consumption request processors (e.g., consumption request processors 242). The consumption request processor 242 is configurable or configured to process consumption requests received from a plurality of users 10 (e.g., via the main interface 201).

In an example embodiment, the consumption request processor 242 is configurable or configured to categorize the information provided in each consumption request. Example categories include, but are not limited to, a unique identifier category (e.g., the unique identifier passed back from the user device 10 to the processor 200 as part of the consumption request), a temporal category (e.g., a date/time stamp when the consumption request was created by the user device 10, sent by the user device 10, or received by the processor 200), a geolocation category (e.g., a geolocation of the user device 10 when the user device 10 created and/or sent the consumption request), and/or a user category (e.g., information pertaining to the user 10, such as user name, user ID, etc.). Categories may also include a product category (e.g., information pertaining to the product having the detectable identifier, such as the brand, product name, product description, product model number, unique product identifier, etc.); merchant category (e.g., information pertaining to the merchant 20 or intermediary 30); gamification category (e.g., information pertaining to any gamification for consuming rewards); etc. After the consumption request processor 242 performs the categorizing of the information found in each consumption request, the categorized information is provided to the consumption verification processor 244 and/or the reward consumption processor 246 for further processing.

The Consumption Verification Processor (e.g., Consumption Verification Processor 244).

As illustrated in FIG. 5, an example embodiment of the consumption processor 240 includes one or more consumption verification processors (e.g., consumption verification processor 244). The consumption verification processor 244 is configurable or configured to receive categorized information from the consumption request processor 242.

Once the consumption verification processor 244 receives the categorized information, the consumption verification processor 244 is configurable or configured to perform a consumption verification process for each consumption request. In performing the consumption verification process, the consumption verification processor 244 cooperates with the main processor 300 to determine, among other things, whether or not the redemption reward can still be consumption, whether the user 10 who sent the consumption request is eligible to consume the redemption reward, whether the consumption of the redemption reward has expired, etc. (or “consumption requirements”, or the like), as further described below and in the present disclosure.

In an example embodiment, the consumption verification process performed by the consumption verification processor 244 includes, but is not limited to, obtaining the unique identifier from the categorized information obtained from the consumption request (i.e., the unique identifier passed back from the user device 10 to the processor 200 as part of the consumption request). The consumption verification processor 244 also obtains information about the user 10 (and/or user device 10) from the consumption request. The consumption verification processor 244 may also obtain more information regarding the user 10, such as via a search in a user database 70 (which may include user information obtained from the user 10 during the configuration or setup process, during subsequent user information updates made by the user 10 after the configuration or setup process, and/or during a redemption reward verification process). User information may include, but is not limited to, information provided by the user 10 during the configuration or setup process for the user 10 (e.g., name of the user 10 (e.g., legal name, first name, last name, middle name or initial, etc.), email address, social media handle or login (e.g., Facebook, Google, etc.), user name, electronic wallet information for receiving redemption rewards, or the like, etc.), transaction history of the user 10, redemption history of the user 10, and/or consumption history of the user 10. The consumption verification processor 244 may also obtain geolocation information of the user 10 or user device 10 from the categorized information obtained from the consumption request (e.g., a geolocation of the user device 10 when the user device 10 created and/or sent the redemption request). The consumption verification processor 244 may also obtain merchant 20 and/or intermediary 30 information (i.e., the merchant 20 and/or intermediary 30 that the user 10 has visited and/or requested to consume the redeemed redemption reward; e.g., if the user 10 has redeemed a redemption reward for a free bottle of Coke, the user 10 may visit a 7 Eleven store to consume the redemption reward, in which case the merchant 20 is 7 Eleven and/or the 7 Eleven store, and in which case the consumption request may have come from the user 10 and/or 7 Eleven) from the categorized information obtained from the consumption request. The consumption verification processor 244 may also obtain temporal information from the categorized information obtained from the consumption request (e.g., a date/time stamp when the consumption request was created by the user device 10, sent by the user device 10, or received by the processor 200). The consumption verification processor 244 may also search for and obtain, via an information payload database 70, the information payload corresponding to the unique identifier obtained from the consumption request (i.e., the information payload for the particular unit of the product purchased, used, and/or otherwise received by the user 10, which is also associated with the detectable identifier detected by the user device 10).

Once the information payload corresponding to the unique identifier has been obtained, the consumption verification processor 244 is configurable or configured to identify, from the information payload, the consumption status for the redemption reward (e.g., whether the consumption status is a consumed status or an unconsumed status) (or “consumption status requirements”, or the like). If the consumption verification processor 244 determines that the consumption status is an unconsumed status, the consumption verification processor 244 then continues with the consumption verification process, as described below and in the present disclosure. If, however, the consumption verification processor 244 determines that the consumption status is a consumed status, the consumption verification processor 244 notifies the reward consumption processor 246 that the user 10 is not eligible to consume the redemption reward and cooperates with the execution processor 250 to notify the user 10 and/or merchant 20 and/or intermediary 30 accordingly (or, in situations where the merchant 20 and/or intermediary 30 allows for multiple and/or alternative redemption rewards to be consumed by the same user 10 and/or different users 10, the consumption verification processor 244 notifies the reward consumption processor 246, which cooperates with the execution processor 250 accordingly). Although example embodiments may provide for the consumption status options for each unit of a product to be the “consumed status” and “unconsumed status”, the consumption status options may also include other statuses and/or vary for one, some or all units of a product without departing from the teachings of the present disclosure.

The consumption verification processor 244 may also be configurable or configured to identify, from the information payload, geolocation eligibilities and/or restrictions for consuming the redemption reward (or “geolocation consumption requirements”, or the like). The geolocation eligibilities and/or restrictions for consumption are then compared to the geolocation information obtained from the consumption request. If the consumption verification processor 244 determines that the geolocation information from the consumption request is acceptable (e.g., is within the geolocation eligibilities and/or is not within the geolocation restrictions), the consumption verification processor 244 then continues with the consumption verification process, as described below and in the present disclosure. If, however, the consumption verification processor 244 determines that the geolocation information from the consumption request is not acceptable (e.g., is not within the geolocation eligibilities and/or is within the geolocation restrictions), the consumption verification processor 244 notifies the reward consumption processor 246 that the user 10 is not eligible to consume the redemption reward and cooperates with the execution processor 250 to notify the user 10 and/or merchant 20 and/or intermediary 30 accordingly (or, in situations where the merchant 20 and/or intermediary 30 allows for alternative redemption rewards to be consumed by users 10 that do not pass geolocation requirements, the consumption verification processor 244 notifies the reward consumption processor 246, which cooperates with the execution processor 250 accordingly). Although typical embodiments may provide for the geolocation eligibilities and/or restrictions for consuming each redemption reward to be the same (e.g., same geolocation eligibilities and restrictions for each unit of a product), the geolocation eligibilities and/or restrictions may also vary for one, some or all redemption rewards (and/or there may be more than one geolocation eligibility and/or restriction for one, some or all units of a product) without departing from the teachings of the present disclosure.

The consumption verification processor 244 may also be configurable or configured to identify, from the information payload, temporal eligibilities and/or restrictions for consuming the redemption reward (or “temporal consumption requirements”, or the like). The temporal eligibilities and/or restrictions for consumption are then compared to the temporal information obtained from the consumption request. If the consumption verification processor 244 determines that the temporal information from the consumption request is acceptable (e.g., is within the temporal eligibilities and/or is not within the temporal restrictions), the consumption verification processor 244 then continues with the consumption verification process, as described below and in the present disclosure. If, however, the consumption verification processor 244 determines that the temporal information from the consumption request is not acceptable (e.g., is not within the temporal eligibilities and/or is within the temporal restrictions), the consumption verification processor 244 notifies the reward consumption processor 246 that the user 10 is not eligible to consuming the redemption reward and cooperates with the execution processor 250 to notify the user 10 and/or merchant 20 and/or intermediary 30 accordingly (or, in situations where the merchant 20 and/or intermediary 30 allows for alternative redemption rewards to be consumable by users 10 that do not pass temporal requirements, the consumption verification processor 244 notifies the reward consumption processor 246, which cooperates with the execution processor 250 accordingly). Although typical embodiments may provide for the temporal eligibilities and/or restrictions for consuming each redemption reward to be the same (e.g., same expiry date for each unit of a product), the temporal eligibilities and/or restrictions may also vary for one, some or all units of a product (and/or there may be more than one temporal eligibility and/or restriction for one, some or all units of a product) without departing from the teachings of the present disclosure.

The consumption verification processor 244 may also be configurable or configured to identify, from the information payload, a redemption status for the particular unit of the product, that is, whether the redemption status is a redeemed status or an unredeemed status (or “redemption status requirements”, or the like). Although a redemption reward cannot be consumed if the redemption reward has not been redeemed, this check may be a backup check in case the redemption status was not updated from an unredeemed status to a redeemed status.

The consumption verification processor 244 may also be configurable or configured to identify, from the information payload, user eligibility and/or restrictions for consuming the redemption reward (or “user consumption requirements”, or the like). The user eligibilities and/or restrictions for consuming are then compared to the user information obtained from the consumption request. If the consumption verification processor 244 determines that the user information from the consumption request is acceptable (e.g., is within the user eligibilities and/or is not within the user restrictions), the consumption verification processor 244 then continues with the consumption verification process, as described below and in the present disclosure. If, however, the consumption verification processor 244 determines that the user information from the consumption request is not acceptable (e.g., is not within the user eligibilities and/or is within the user restrictions), the consumption verification processor 244 notifies the reward consumption processor 246 that the user 10 is not eligible to consume the redemption reward and cooperates with the execution processor 250 to notify the user 10 and/or merchant 20 and/or intermediary 30 accordingly (or, in situations where the merchant 20 and/or intermediary 30 allows for alternative redemption rewards to be consumable by users 10 that do not pass user requirements, the consumption verification processor 244 notifies the reward consumption processor 246, which cooperates with the execution processor 250 accordingly).

The consumption verification processor 244 may also be configurable or configured to identify, from the information payload, gamification requirements for consuming the redemption reward (or “gamification consumption requirements”, or the like). The gamification consumption requirements are then compared to the gamification information obtained from the consumption request and/or another source (e.g., outcome of any games that the user 10 was required to play before a consumption request is sent to the processor 200, which may be sent in the consumption request and/or or obtainable from a gamification processor/database, or the like). If the consumption verification processor 244 determines that the gamification information from the consumption request is acceptable (e.g., gamification requirements are satisfied), the consumption verification processor 244 then continues with the consumption verification process, as described below and in the present disclosure. If, however, the consumption verification processor 244 determines that the gamification information from the consumption request is not acceptable (e.g., gamification requirements are not satisfied), the consumption verification processor 244 notifies the reward consumption processor 246 that the user 10 is not eligible to redeem a consumption reward and cooperates with the execution processor 250 to notify the user 10 and/or merchant 20 and/or intermediary 30 accordingly (or, in situations where the merchant 20 and/or intermediary 30 allows for alternative redemption rewards to be consumable by users 10 that do not pass gamification requirements, the consumption verification processor 244 notifies the reward consumption processor 246, which cooperates with the execution processor 250 accordingly).

After the consumption verification processor 244 verifies the consumption requirements (including the consumption status requirements, temporal consumption requirements, geolocation consumption requirements, user consumption requirements, redemption status requirements, gamification consumption requirements, etc.), the consumption verification processor 244 is configurable or configured to identify, from the information payload, the redemption reward(s) consumable by the user 10 for the particular unit of the product. In example embodiments where the redemption rewards are in the form of a digital asset (e.g., digital token, digital coupon, digital badge, cryptocurrency, etc.), the consumption verification processor 244 is configurable or configured to identify an electronic wallet of the user 10 (e.g., from the user information obtained from the consumption request; from information obtainable from a user database 70; etc.) that will consume the redemption reward(s) (i.e., where the redemption rewards are coming from). The consumption verification processor 244 then provides, among other things, the redemption reward(s) to be consumed (e.g., more information, quantity, etc.) and electronic wallet information of the user 10 to the reward consumption processor 246 for further processing. Alternatively, if the redemption rewards are not in the form of a digital asset (e.g., for the redeeming of the redemption rewards, a simple message was sent to the dedicated mobile app of the user 10, an email or SMS message was sent to the user 10, information was sent to the dedicated mobile app of the user 10 to render a graphical or textual representation of the redeemed redemption reward (e.g., in the form of a frequent collector card having sections for redemption rewards in the form of stamps to appear therein), etc.), the consumption verification processor 244 provides, among other things, the redemption reward(s) to be consumed and information regarding the user 10 to the reward consumption processor 246 for further processing (e.g., another simple consumption message to be sent to the dedicated mobile app of the user 10, a consumption email or SMS message to be sent to the user 10, consumption information to be sent to the dedicated mobile app of the user to remove and/or add a “consumed” graphical or textual representation of the consumed redemption reward (e.g., putting an “X” across the frequent collector card, removing or deleting the frequent collector card, etc.).

The Reward Consumption Processor (e.g., Reward Consumption Processor 246).

As illustrated in FIG. 5, an example embodiment of the consumption processor 240 includes one or more reward consumption processors (e.g., reward consumption processor 246). The reward consumption processor 246 is configurable or configured to receive information from the consumption request processor 242 and information from the consumption verification processor 244.

Once the reward consumption processor 246 receives the information, the reward consumption processor 246 is configurable or configured to process each consumption request. For those consumption requests in which the consumption verification processor 244 determines that all consumption requirements are met, the reward consumption processor 246 cooperates with the main processor 300 and one or more databases, including the information set database 70, to update the information set for the particular unit of the product (e.g., update the consumption status from the unconsumed status to the consumed status, etc.). The reward consumption processor 246 then cooperates with the execution processor 250 to consume the redemption rewards (e.g., transfer from the user 10; delete or cancel for the user 10; etc.). The redemption rewards may be transferred from an electronic wallet of the user 10. In example embodiments where the redemption rewards are in the form of a digital asset (e.g., digital token, digital coupon, digital badge, cryptocurrency, etc.), the transferring of the redemption rewards from the user 10 may include recording, in a distributed ledger (e.g., blockchain, or the like), a transfer of such digital asset from the electronic wallet of the user 10 to another electronic wallet (e.g., electronic wallet of the merchant 20, intermediary 30, a “consumed” wallet, etc.).

For those consumption requests in which the consumption verification processor 244 determines that one or more of the consumption requirements are not met (e.g., the redemption reward has already been consumed, the consumption expiry date has already passed, the user 10 is in a non-eligible location, etc.), the reward consumption processor 246 is configurable or configured to cooperate with the main processor 300 and one or more databases, including the information set database 70, to update the information set for the particular unit of the product (e.g., failed attempts of consumption, date/time of the failed consumption request, user 10 who submitted the failed consumption request, etc.). The reward consumption processor 246 then cooperates with the execution processor 250 to notify the user 10 that the consumption request did not succeed.

The Main Processor (e.g., Main Processor 300).

As illustrated in FIG. 2, an example embodiment of the processor 200 includes one or more main processors (e.g., main processors 300). The main processor 300 is configurable or configured to cooperate with one or more elements of the processor 200, including the main interface 210, the setup processor 220, the redemption processor 230, the consumption processor 240, and/or the execution processor 250, to process, among other things, configuration or setup requests, redemption requests, and/or consumption requests. The processing may include performing a configuration or setup process, redemption process, and/or consumption verification process, as described in the present disclosure.

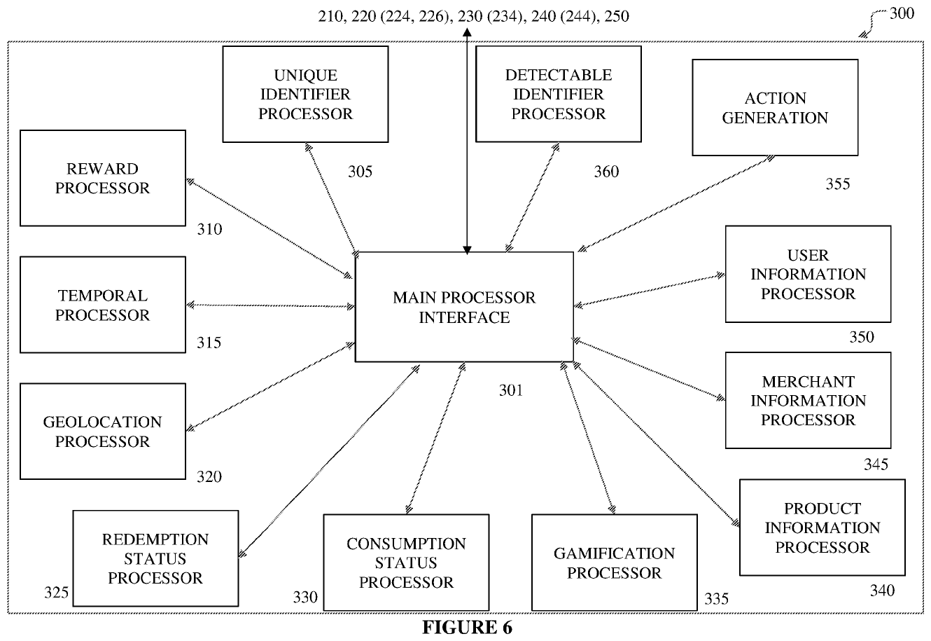

To perform these processes and/or methods, example embodiments of the main processor 300 include one or more elements. For example, as illustrated in FIG. 6, the main processor 300 includes one or more unique identifier processors 305. The main processor 300 also includes one or more reward processors 310. The main processor 300 also includes one or more temporal processors 315. The main processor 300 also includes one or more geolocation processors 320. The main processor 300 also includes one or more redemption status processors 325. The main processor 300 also includes one or more consumption status processors 330. The main processor 300 also includes one or more gamification processors 335. The main processor 300 also includes one or more product information processors 340. The main processor 300 also includes one or more merchant processors 345. The main processor 300 also includes one or more user information processors 350. The main processor 300 also includes one or more action processors 355. The main processor 300 also includes one or more detectable identifier processors 360. Although the figures may illustrate one unique identifier processor 305, one reward processor 310, one temporal processor 315, one geolocation processor 320, one redemption status processor 325, one consumption status processor 330, one gamification processor 335, one product information processor 340, one merchant information processor 345, one user information processor 350, one action generator 355, and one detectable identifier processor 360, it is to be understood in the present disclosure that the main processor 300 may include more or less than one unique identifier processor 305, more or less than one reward processor 310, more or less than one temporal processor 315, more or less than one geolocation processor 320, more or less than one redemption status processor 325, more or less than one consumption status processor 330, more or less than one gamification processor 335, more or less than one product information processor 340, more or less than one merchant information processor 345, more or less than one user information processor 350, more or less than one action generator 355, and/or more or less than one detectable identifier processor 360 without departing from the teachings of the present disclosure. It is also to be understood in the present disclosure that, although the functions and/or processes performed by the main processor 300 are described in the present disclosure as being performed by particular elements of the main processor 300, the functions and/or processes performed by a particular element of the main processor 300 may also be performed by one or more other elements and/or cooperatively performed by more than one element of the processor 200 without departing from the teachings of the present disclosure. It is also to be understood that, although the functions and/or processes performed by the main processor 300 are described in the present disclosure as being performed by particular elements of the main processor 300, the functions and/or processes performed by two or more particular elements of the main processor 300 may be combined and performed by one element of the processor 200 without departing from the teachings of the present disclosure.

These elements of the main processor 300 will now be further described with reference to the accompanying figures.

The Main Processor Interface (e.g., Main Processor Interface 301).

As illustrated in FIG. 6, an example embodiment of the main processor 240 includes one or more main processor interfaces (e.g., main processor interface 301). The main processor interface 301 is configurable or configured to exchange information with one or more elements of the processor 200, including the main interface 210, the setup processor 220, the redemption processor 230, the consumption processor 240, and/or the execution processor 250. The main processor interface 301 is then configurable or configured to provide information to one or more of the elements of the main processor 300.

The Unique Identifier Processor (e.g., Unique Identifier Processor 305).

As illustrated in FIG. 6, an example embodiment of the main processor 240 includes one or more unique identifier processors (e.g., unique identifier processor 305). As described in the present disclosure, the unique identifier processor 305 is configurable or configured to generate and/or obtain new unique identifiers during a configuration or setup process, and provide such new unique identifiers to the setup processor 220 (and/or one or more elements of the processor 200). For example, the unique identifier processor 305 may be configurable or configured to access a unique identifier database 70 to obtain new unique identifiers for inclusion in new information payloads (and also to be associated with new detectable identifiers). Alternatively or in addition, the unique identifier processor 305 may be configurable or configured to access a unique identifier generator (not shown) to generate new unique identifiers. As described in the present disclosure, the unique identifier processor 305 is also configurable or configured to check, verify, and/or confirm unique identifiers received from redemption requests and/or consumption requests during redemption processes and/or consumption processes (and/or pursuant to transfer requests during transfer processes between users 10), respectively, and provide results to the redemption processor 230 and/or consumption processor 240. The unique identifier processor 305 is also configurable or configured to store, cancel, and/or re-use unique identifiers.

The Reward Processor (e.g., Reward Processor 310).

As illustrated in FIG. 6, an example embodiment of the main processor 240 includes one or more reward processors (e.g., reward processor 310). As described in the present disclosure, the reward processor 310 is configurable or configured to generate and/or obtain new redemption rewards during a configuration or setup process, and provide such new redemption rewards to the setup processor 220 (and/or one or more elements of the processor 200). For example, the reward processor 310 may be configurable or configured to access a redemption rewards database 70 to obtain new redemption rewards for inclusion in new information payloads (and also to be associated with new detectable identifiers). Alternatively or in addition, the reward processor 310 may be configurable or configured to access a redemption reward generator (not shown) to generate new redemption rewards. As described in the present disclosure, the reward processor 310 is also configurable or configured to check, verify, and/or confirm redemption rewards (e.g., whether such redemption rewards are valid, fraudulent, counterfeit, fake, etc.) that have been requested to be redeemed and/or consumed (and/or transferred between users 10), and provide results to the redemption processor 230 and/or consumption processor 240. The reward processor 310 is also configurable or configured to store, transfer, cancel, and/or re-use redemption rewards. In regards to transfers, the reward processor 310 is configurable to process transfers/redeeming of redemption rewards to users 10 (e.g., pursuant to a redemption request), transfers of redemption rewards between users 10 (e.g., one user 10 transfers a redeemed redemption request to another use 10), and/or transfers/consuming of redemption rewards from users 10 to merchants 20, intermediaries 30, “consumed” electronic wallets, or the like (e.g., pursuant to a consumption request).

The Temporal Processor (e.g., Temporal Processor 315).

As illustrated in FIG. 6, an example embodiment of the main processor 240 includes one or more temporal processors (e.g., temporal processor 315). As described in the present disclosure, the temporal processor 315 is configurable or configured to generate and/or obtain temporal information/requirements (e.g., temporal eligibilities such as when redemption rewards can be redeemed and/or consumed; temporal restrictions such as when redemption rewards cannot be redeemed and/or consumed; etc.) during a configuration or setup process, and provide such new temporal information/requirements to the setup processor 220 (and/or one or more elements of the processor 200). For example, the temporal processor 315 may be configurable or configured to access a temporal database 70 to obtain new temporal information/requirements for inclusion in new information payloads. Alternatively or in addition, the temporal processor 315 may be configurable or configured to access a temporal generator (not shown) to generate new temporal information/requirements. As described in the present disclosure, the temporal processor 315 is also configurable or configured to check, verify, and/or confirm temporal requirements against temporal information received from redemption requests and/or consumption requests (and/or transferred between users 10), and provide results to the redemption processor 230 and/or consumption processor 240. The temporal processor 315 is also configurable or configured to store, cancel, and/or modify temporal information/requirements.

The Geolocation Processor (e.g., Geolocation Processor 320).

As illustrated in FIG. 6, an example embodiment of the main processor 240 includes one or more geolocation processors (e.g., geolocation processor 320). As described in the present disclosure, the geolocation processor 320 is configurable or configured to generate and/or obtain geolocation information/requirements (e.g., geolocation eligibilities such as which location(s) redemption rewards can be redeemed and/or consumed; geolocation restrictions such as which location(s) redemption rewards cannot be redeemed and/or consumed; etc.) during a configuration or setup process, and provide such new geolocation information/requirements to the setup processor 220 (and/or one or more elements of the processor 200). For example, the geolocation processor 320 may be configurable or configured to access a geolocation database 70 to obtain new geolocation information/requirements for inclusion in new information payloads. Alternatively or in addition, the geolocation processor 320 may be configurable or configured to access a geolocation generator (not shown) to generate new geolocation information/requirements. As described in the present disclosure, the geolocation processor 320 is also configurable or configured to check, verify, and/or confirm geolocation requirements against geolocation information received from redemption requests and/or consumption requests (and/or transferred between users 10), and provide results to the redemption processor 230 and/or consumption processor 240. The geolocation processor 320 is also configurable or configured to store, cancel, and/or modify geolocation information/requirements.

The Redemption Status Processor (e.g., Redemption Status Processor 325).

As illustrated in FIG. 6, an example embodiment of the main processor 240 includes one or more redemption status processors (e.g., redemption status processor 325). As described in the present disclosure, the redemption status processor 325 is configurable or configured to generate and/or obtain one or more redemption statuses (e.g., a “redeemed” status, an “unredeemed” status, etc.) during a configuration or setup process, and provide such new redemption statuses to the setup processor 220 (and/or one or more elements of the processor 200). For example, the redemption status processor 325 may be configurable or configured to access a redemption status database 70 to obtain new redemption statuses for inclusion in new information payloads. As described in the present disclosure, the redemption status processor 325 is also configurable or configured to check, verify, and/or confirm redemption statuses in information payloads to determine whether or not a redemption reward has been redeemed, and provide results to the redemption processor 230 and/or consumption processor 240. The redemption status processor 325 is also configurable or configured to store, cancel, and/or modify redemption statuses.

The Consumption Status Processor (e.g., Consumption Status Processor 330).

As illustrated in FIG. 6, an example embodiment of the main processor 240 includes one or more consumption status processors (e.g., consumption status processor 330). As described in the present disclosure, the consumption status processor 330 is configurable or configured to generate and/or obtain one or more consumption statuses (e.g., a “consumed” status, an “unconsumed” status, etc.) during a configuration or setup process, and provide such new consumption statuses to the setup processor 220 (and/or one or more elements of the processor 200). For example, the consumption status processor 330 may be configurable or configured to access a consumption status database 70 to obtain new consumption statuses for inclusion in new information payloads. As described in the present disclosure, the consumption status processor 330 is also configurable or configured to check, verify, and/or confirm consumption statuses in information payloads to determine whether or not a redemption reward has been consumed, and provide results to the redemption processor 230 and/or consumption processor 240. The consumption status processor 330 is also configurable or configured to store, cancel, and/or modify consumption statuses.

The Gamification Processor (e.g., Gamification Processor 335).

As illustrated in FIG. 6, an example embodiment of the main processor 240 includes one or more gamification processors (e.g., gamification processor 335). As described in the present disclosure, the gamification processor 335 is configurable or configured to generate and/or obtain gamification information/requirements (e.g., games that need to be played/won before a redemption and/or consumption of redemption rewards) during a configuration or setup process, and provide such new gamification information/requirements to the setup processor 220 (and/or one or more elements of the processor 200). For example, the gamification processor 335 may be configurable or configured to access a gamification database 70 to obtain new gamification information/requirements for inclusion in new information payloads. Alternatively or in addition, the gamification processor 335 may be configurable or configured to access a gamification generator (not shown) to generate new gamification information/requirements. As described in the present disclosure, the gamification processor 335 is also configurable or configured to check, verify, and/or confirm gamification requirements against gamification information/results received from redemption requests and/or consumption requests (and/or via the gamification database 70), and provide results to the redemption processor 230 and/or consumption processor 240. The gamification processor 335 is also configurable or configured to store, cancel, and/or modify gamification information/requirements.

The Product Information Processor (e.g., Product Information Processor 340).

As illustrated in FIG. 6, an example embodiment of the main processor 240 includes one or more product information processors (e.g., product information processor 340). As described in the present disclosure, the product information processor 340 is configurable or configured to generate, obtain, and/or store product information during a configuration or setup process, and provide such product information to the setup processor 220 (and/or one or more elements of the processor 200). For example, the product information processor 340 may be configurable or configured to access a product information database 70 to obtain product information for inclusion in new information payloads. The product information processor 340 is also configurable or configured to store, cancel, and/or modify product information.

The Merchant Information Processor (e.g., Merchant Information Processor 345).

As illustrated in FIG. 6, an example embodiment of the main processor 240 includes one or more merchant information processors (e.g., merchant information processor 345). As described in the present disclosure, the merchant information processor 345 is configurable or configured to generate and/or obtain merchant information (i.e., the merchant 20 and/or intermediary 30 who is offering the redemption rewards; and/or the merchant 20 and/or intermediary 30 whose product will include the detectable identifier) and/or participating merchant 20 and/or intermediary 30 information/requirements (merchants 20 and/or intermediaries 30 who are participating in allowing users 10 to consume redemption rewards; e.g., those merchants 20 and/or intermediaries 30 who will accept redeemed redemption rewards from users 10 and allow users 10 in exchange for free products and/or services) during a configuration or setup process, and provide such new merchant 20 and/or intermediary 30 information and/or participating merchant information/requirements to the setup processor 220 (and/or one or more elements of the processor 200). For example, the merchant information processor 345 may be configurable or configured to access a merchant information database 70 to obtain new participating merchant 20 and/or intermediary 30 information/requirements for inclusion in new information payloads. As described in the present disclosure, the merchant information processor 345 is also configurable or configured to check, verify, and/or confirm participating merchant 20 and/or intermediary 30 requirements against information in redemption requests and/or consumption requests received from users 10, merchants 20, and/or intermediaries 30, and provide results to the redemption processor 230 and/or consumption processor 240. The merchant information processor 345 is also configurable or configured to store, cancel, and/or modify merchant information information/requirements.

The User Information Processor (e.g., User Information Processor 350).

As illustrated in FIG. 6, an example embodiment of the main processor 240 includes one or more user information processors (e.g., user information processor 350). As described in the present disclosure, the user information processor 350 is configurable or configured to generate and/or obtain user information (i.e., the user 10 who is redeeming and/or consuming the redemption reward) and/or eligible user requirements (users 10 who are eligible to redeem and/or consume the redemption reward, and may also include users 10 who are not eligible or restricted from redeeming and/or consuming the redemption reward) during a configuration or setup process, and provide such new user 10 information and/or eligible user requirements to the setup processor 220 (and/or one or more elements of the processor 200). For example, the user information processor 350 may be configurable or configured to access a user information database 70 to obtain new eligible user requirements for inclusion in new information payloads. As described in the present disclosure, the user information processor 350 is also configurable or configured to check, verify, and/or confirm eligible user requirements against user 10 information in redemption requests and/or consumption requests received from users 10, merchants 20, and/or intermediaries 30, and provide results to the redemption processor 230 and/or consumption processor 240. The user information processor 350 is also configurable or configured to store, cancel, and/or modify user information information/requirements.

The Function or Action Generator (e.g., Action Generator 355).

As illustrated in FIG. 6, an example embodiment of the main processor 240 includes one or more function or action generators (e.g., action generator 355). As described in the present disclosure, the action generator 355 is configurable or configured to generate and/or obtain one or more commands (as described in the present disclosure, such one or more commands are commands that, when read by a user device 10 that has detected the detectable identifier, causes or requests the user device 10 to perform one or more actions) during a configuration or setup process, and provide such new commands to the setup processor 220 (and/or one or more elements of the processor 200). For example, the action processor 355 may be configurable or configured to access a command database 70 to obtain new commands and/or actions for inclusion in new information payloads. Alternatively or in addition, the action generator 355 may be configurable or configured to access a command generator (not shown) to generate new commands (and corresponding actions). As described in the present disclosure, the action generator 355 is also configurable or configured to check, verify, and/or confirm that such commands and/or actions are performed by the user device 10, and provide results to the redemption processor 230 and/or consumption processor 240. The action processor 355 is also configurable or configured to store, cancel, and/or modify commands and/or actions.

The Detectable Identifier Processor (e.g., Detectable Identifier Processor 360).

As illustrated in FIG. 6, an example embodiment of the main processor 240 includes one or more detectable identifier processors (e.g., detectable identifier processor 360). As described in the present disclosure, the detectable identifier processor 360 is configurable or configured to generate and/or obtain one or more new/unique detectable identifiers during a configuration or setup process, and provide such new detectable identifiers to the setup processor 220 (and/or one or more elements of the processor 200). For example, the detectable identifier processor 360 may be configurable or configured to access a detectable identifier database 70 to obtain new detectable identifiers for association and/or inclusion in new information payloads. Alternatively or in addition, the detectable identifier processor 360 may be configurable or configured to access a detectable identifier generator (not shown) to generate new detectable identifiers (and corresponding commands and corresponding actions). The detectable identifier processor 360 is also configurable or configured to store, cancel, and/or modify detectable identifiers, commands, and/or actions.

Example Embodiments of a Method for Managing Information between Merchants, Intermediaries, and/or Users (e.g., Method 700).

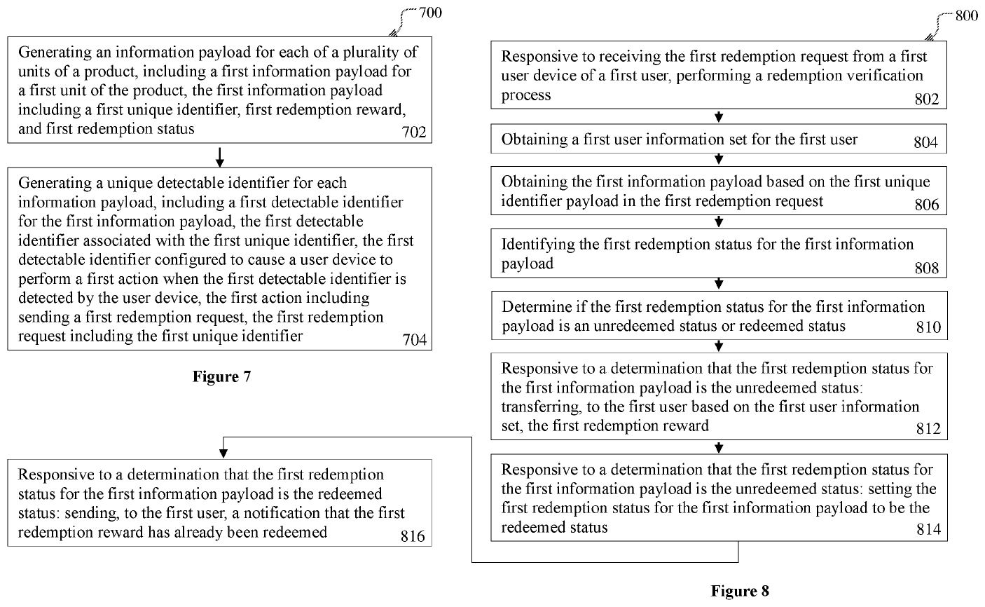

FIG. 7 illustrates an example embodiment of a method (e.g., method 700) of managing information between merchants, intermediaries, and/or users. The method 700 may be for use in performing a configuration or setup process pursuant to receiving a configuration or setup request (as described in the present disclosure). In an example embodiment, the method 700 may be performable by example embodiments of the setup processor 220.

The method 700 includes generating an information payload for each of a plurality of units of a product (e.g., action 702). The method 700 also includes generating a unique detectable identifier for each information payload (e.g., action 704).

These and other processes and/or actions of method 700 will now be further described with reference to the accompanying figures.

Generating an Information Payload for Each of a Plurality of Units of a Product (e.g., Action 702).

In an example embodiment, the method 700 includes generating an information payload for each of a plurality of units of a product (e.g., action 702). As described in the present disclosure, an example embodiment of the information payload generator 224 is configurable or configured to generate information payloads.

Each information payload generated for each unit of a product includes a unique identifier. Each information payload also includes one or more redemption rewards that are redeemable by a user 10 upon detecting a detectable identifier (e.g., a QR code attached a particular unit of a product) associated with the information payload. Each information payload also includes a redemption status (e.g., redeemed or unredeemed), which represents a status of whether or not the one or more redemption rewards have been redeemed for the particular unit of the product. Each information payload may also include temporal requirements, which may include temporal eligibilities (e.g., dates when the redemption reward can be redeemed) and/or temporal restrictions (e.g., dates when the redemption reward cannot be redeemed, such as after an expiry date). Each information payload may also include geolocation requirements, which may include geolocation eligibilities (e.g., location(s) where the redemption reward can be redeemed) and/or geolocation restrictions (e.g., location(s) where the redemption reward cannot be redeemed). Each information payload may also include a consumption status (e.g., consumed or unconsumed), which represents a status of whether or not the one or more redemption rewards have been consumed for the particular unit of the product. Each information payload may also include a gamification requirement, which represents one or more games that must be played, won, entered into, participated in, etc. by a user 10 before the user 10 can redeem (and/or submit a redemption request) and/or consume (and/or submit a consumption request). Each information payload may also include product information, which may include a brand, product name, product description, product type, product origin, product model number, unique product identifier, etc. Each information payload may also include merchant information, which may include information regarding the merchant 20 and/or intermediary 30 who provided the product. Merchant information may also include participating merchants 20 and/or intermediaries where a user 10 may consume redeemed redemption rewards. Each information payload may also include user information, which may include information regarding user(s) 10 who have redeemed and/or consumed the product. User information may also include user eligibilities (e.g., users 10 who are eligible to redeem the redemption rewards) and/or user restrictions (e.g., users 10 who are ineligible, restricted, etc. form redeeming the redemption rewards). Each information payload may also include detectable identifier information, which may include information regarding the detectable identifier associated with the information payload (i.e., attached to or associated with the product), the one or more commands that are read by a user device 10 upon detecting the detectable identifier, and the one or more actions performed by the user device 10 upon reading the one or more commands (as described in the present disclosure). For example, a first information payload is generated for a first unit of a product, a second information payload is generated for a second unit of the product, and so on. The first information payload may include a first unique identifier, a first redemption reward (e.g., a first quantity of a digital token), a first redemption status (e.g., unredeemed), a first temporal requirement (e.g., redemption expiry of 15 May 2021; consumption expiry of 3 months after date of redeeming redemption reward), a first geolocation requirement (e.g., redeemable and consumable only in Singapore), a first consumption status (e.g., unconsumed), a first gamification requirement (e.g., none), a first product information (e.g., box of ice cream), a first merchant information (e.g., Ben & Jerry's), a first user information (e.g., no user has redeemed, no user has consumed, no user restrictions), and a first detectable identifier information (including a first command and a first action) (e.g., a unique QR code having a command being a deep link with the first unique identifier and an action being to launch the deep link to open an installed dedicated mobile app on the user device 10 and send a redemption request (while also passing back the first unique identifier)). The second information payload may include a second unique identifier (different from the first unique identifier), a second redemption reward (same as the first redemption reward), a second redemption status (e.g., unredeemed), a second temporal requirement (same as the first temporal requirement), a second geolocation requirement (same as the first geolocation requirement), a second consumption status (e.g., unconsumed), a second gamification requirement (same as the first gamification requirement), a second product information (same as the first product information), a second merchant information (same as the first merchant information), a second user information (may be different from the first user information if the user who redeems and/or consumes the second unit is different from the user who redeems and/or consumes the first unit), a second detectable identifier information (including a second command and a second action) (different from the first detectable identifier).

Generating a Unique Detectable Identifier for Each Information Payload (e.g., Action 704).

In an example embodiment, the method 700 includes generating a unique detectable identifier for each information payload (e.g., action 704). As described in the present disclosure, an example embodiment of the detectable identifier generator 226 is configurable or configured to generate unique detectable identifiers.

Each unit of a product is provided with a unique detectable identifier. Each detectable identifier includes one or more commands (as described in the present disclosure) that are read by a user device 10 upon detecting the detectable identifier. The one or more commands, when read by a user device 10 upon detecting the detectable identifier, causes and/or requests the user device 10 to perform one or more actions (as described in the present disclosure). For example, when the detectable identifier is a unique QR code, the one or more actions may include obtaining a unique identifier from the detecting of the detectable identifier, followed by sending a redemption request along with the unique identifier back to the processor 200.

Example Embodiments of a Method for Managing Information between Merchants, Intermediaries, and/or Users (e.g., Method 800).

FIG. 8 illustrates an example embodiment of a method (e.g., method 800) of managing information between merchants, intermediaries, and/or users. The method 800 may be for use in performing a redemption process pursuant to receiving a redemption request (as described in the present disclosure). In an example embodiment, the method 800 may be performable by example embodiments of the redemption processor 230.

The method 800 includes performing a redemption verification process upon receiving a redemption request from a first user 10 of a first device 10 (e.g., action 802). The redemption request may be performed by the redemption processor 230. The redemption request may be sent by the first user device 10 after the first user device 10 detects a first detectable identifier attached to a first unit of a product (which was purchased, used, and/or otherwise received by the first user 10). The redemption request includes a first unique identifier. The method 800 also includes obtaining information for the first user 10 (e.g., a first user information set) (e.g., action 804). The first user information may include a user name, user ID, geolocation, current timestamp, and an electronic wallet for the user 10 to receive redemption rewards. The method 800 includes searching for and obtaining an information payload for the first unit of the product based on the first unique identifier in the redemption request (e.g., action 806). The method 800 includes identifying the first redemption status for the information payload (e.g., action 808). The method 800 includes determining whether the first redemption status for the information payload is an unredeemed status or the redeemed status (e.g., action 810). The method 800 also includes identifying a first redemption reward for the information payload. The method 800 also includes, responsive to a determination that the first redemption status for the information payload is the unredeemed status, transferring the first redemption reward to the first user 10 (e.g., action 812) and setting the first redemption status for the information payload to be the redeemed status (e.g., action 814). The method 800 also includes, responsive to a determination that the first redemption status for the information payload is the redeemed status, sending a notification to the first user that the first redemption reward has already been redeemed.

Example Embodiments of a Method for Managing Information between Merchants, Intermediaries, and/or Users (e.g., Method 900).

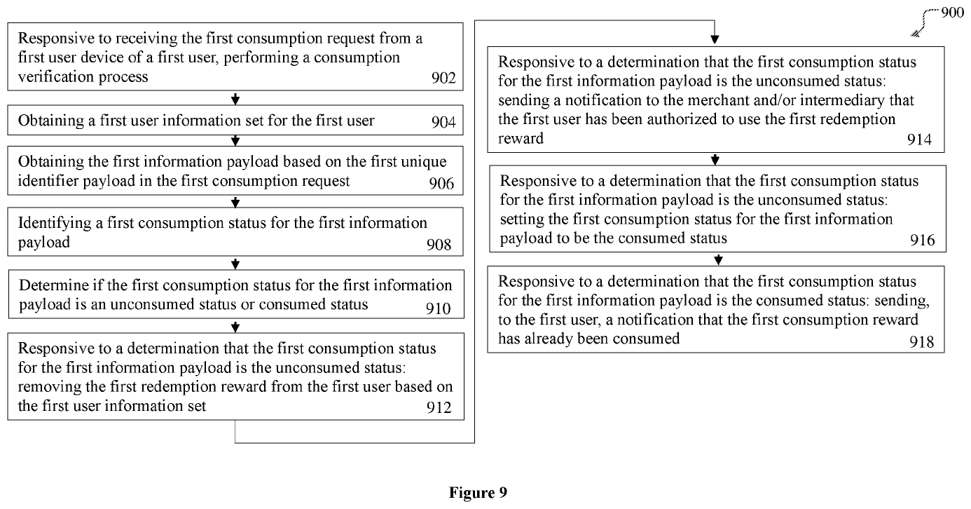

FIG. 9 illustrates an example embodiment of a method (e.g., method 900) of managing information between merchants, intermediaries, and/or users. The method 900 may be for use in performing a consumption process pursuant to receiving a consumption request (as described in the present disclosure). In an example embodiment, the method 900 may be performable by example embodiments of the consumption processor 240.

The method 900 includes performing a consumption verification process upon receiving a consumption request from a first user 10 of a first device 10 (e.g., action 902). The consumption request may be performed by the consumption processor 240. The consumption request may be sent by the first user device 10 when the first user 10 wants to consume a redemption request that has been redeemed by the first user 10. The consumption request includes a first unique identifier. The method 900 also includes obtaining information for the first user 10 (e.g., a first user information set) (e.g., action 904). The first user information may include a user name, user ID, geolocation, current timestamp, and an electronic wallet where the user 10 has the redeemed redemption rewards. The method 900 includes searching for and obtaining an information payload for the first unit of the product based on the first unique identifier in the consumption request (e.g., action 906). The method 900 includes identifying the first consumption status for the information payload (e.g., action 908). The method 900 includes determining whether the first consumption status for the information payload is an unconsumed status or the consumed status (e.g., action 910). The method 900 also includes identifying which or a quantity of redemption rewards needed to be consumed. The method 900 also includes, responsive to a determination that the first consumption status for the information payload is the unconsumed status, removing the identified type and/or quantity of redemption rewards from the first user 10 (e.g., transferring such redemption rewards from the electronic wallet of the first user 10) (e.g., action 912), sending a notification to the first user 10, merchant 20, and/or intermediary 30 that the first user 10 has been authorized to consume the redemption rewards (e.g., action 914), and setting the first consumption status for the information payload to be the consumed status (e.g., action 916). The method 900 also includes, responsive to a determination that the first consumption status for the information payload is the consumed status, sending a notification to the first user 10 that the first redemption reward has already been consumed.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, “communication,” “communicate,” “connection,” “connect,” “call,” “calling,” or other similar terms should generally be construed broadly to mean a wired, wireless, and/or other form of, as applicable, connection between elements, devices, computing devices, telephones, processors, controllers, servers, networks, telephone networks, the cloud, and/or the like, which enable voice and/or data to be sent, transmitted, broadcasted, received, intercepted, acquired, and/or transferred (each as applicable).

As another example, “user,” “candidate user,” “selected user,” “final user,” or similar terms should generally be construed broadly to mean a user, either registered or unregistered, who has been selected by one or more elements of the processor (e.g., processor 150), and such user may be a selected user subject to further processing by one or more elements of the processor or a selected user who will receive an offer (e.g., via a notification) to receive distributed ledger data (e.g., digital tokens, cryptocurrency, etc.).

Also, as referred to herein, a processor, device, computing device, telephone, phone, server, gateway server, communication gateway server, and/or controller, may be any processor, computing device, and/or communication device, and may include a virtual machine, computer, node, instance, host, or machine in a networked computing environment. Also as referred to herein, a network or cloud may be or include a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Database (or memory or storage) may comprise any collection and/or arrangement of volatile and/or non-volatile components suitable for storing data. For example, memory may comprise random access memory (RANI) devices, read-only memory (ROM) devices, magnetic storage devices, optical storage devices, solid state devices, and/or any other suitable data storage devices. In particular embodiments, database may represent, in part, computer-readable storage media on which computer instructions and/or logic are encoded. Database may represent any number of memory components within, local to, and/or accessible by a processor and/or computing device.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method of managing transactions made by end users, the method comprising:
generating, by a processor, an information payload for each of a plurality of units of a first product, including a first unit information payload for a first unit of the first product, the first unit information payload for the first unit of the first product being different from a second unit information payload for a second unit of the first product, the first unit information payload for the first unit of the first product including:
a first unique identifier for the first unit information payload;
a first redemption reward for the first unit of the first product, the first redemption reward being a digital asset representing a reward redeemable by a user who has purchased the first unit of the first product, the first redemption reward configured to be transferrable, by the processor, to one of a plurality of users who has purchased the first unit of the first product based on a redemption verification process;
a first redemption status for the first unit information payload, the first redemption status being:
an unredeemed status when the first redemption reward has not yet been transferred to any of the plurality of users; or
a redeemed status when the first redemption reward has been transferred to one of the plurality of users;
a first geolocation requirement for the first unit information payload;
a first temporal requirement for the first unit information payload; and a first user requirement for the first unit information payload;
generating, by the processor, a unique detectable identifier for each information payload, including a first detectable identifier for the first unit information payload, the first detectable identifier associated with the first unique identifier for the first unit information payload, the first detectable identifier configured to cause a user device to perform a first action when the first detectable identifier is detected by the user device, the first action including:
sending, to the processor, a first redemption request, the first redemption request including the first unique identifier for the first unit information payload; and
responsive to receiving, by the processor, the first redemption request from a first user device of a first user, performing the redemption verification process for the first redemption request, the redemption verification process including:
obtaining a first user information set for the first user;
determining a geolocation of the first user device;
determining a timestamp associated with the first redemption request;
obtaining, based on the first unique identifier for the first unit information payload in the first redemption request, the first unit information payload;
identifying the first redemption status for the first unit information payload;
identifying the first geolocation requirement for the first unit information payload;
identifying the first temporal requirement for the first unit information payload;
identifying the first user requirement for the first unit information payload;
responsive to a determination that the first redemption status for the first unit information payload is the unredeemed status, the geolocation of the first user device meets the first geolocation requirement, the timestamp of the first redemption request meets the first temporal requirement, and the first user meets the first user requirement based on the first user information set:
transferring, by the processor to the first user based on the first user information set, the first redemption reward for the first unit information payload; and
setting the first redemption status for the first unit information payload to be the redeemed status; and
responsive to a determination that the first redemption status for the first unit information payload is the redeemed status and/or the geolocation of the first user device does not meet the first geolocation requirement and/or the timestamp of the first redemption request does not meet the first temporal requirement and/or the first user does not meet the first user requirement:
sending, by the processor to the first user, a notification that the first redemption reward is not redeemable.

2. The method of claim 1, wherein one or more at least one of the following apply:
the first temporal requirement includes at least one of the following:
a first expiry date for the first unit information payload, the first expiry date for the first unit information payload being a last date on which the first redemption reward can be transferred to one of the plurality of users; or
a first relevant date for the first unit information payload, the first relevant date for the first unit information payload being a date on which a value of the first redemption reward changes from a first value to a second value;
the timestamp of the first redemption request is one or more at least one of the following:
a timestamp when the first user device detected the first detectable identifier;
a timestamp when the first user device sent the first redemption request; and/or or
a timestamp when the process received the first redemption request:,
the first geolocation requirement includes at least one of the following:
one or more geolocation regions where the first redemption award can be redeemed; or
one or more geolocation regions where the first redemption award cannot be redeemed;
the first detectable identifier is a unique QR code;
the first detectable identifier is detected by the first user device via image capturing of the unique QR code by the first user device;
the first detectable identifier includes at least one of the following:
a unique QR code;
a unique bar code; or
a unique sequence of characters;
the first user information set includes an address of a digital wallet of the user;
the transferring of the first redemption reward includes transferring the first redemption reward to the address of the digital wallet of the first user; and
the first redemption reward for the first unit information payload includes at least one of the following:
a digital stamp;
a digital badge;
a feature on the digital badge;
a quantity of digital tokens; or
a digital coupon.

3. (canceled)

4. The method of claim 1, wherein:
the first redemption request further includes the geolocation of the first user device; and
the redemption verification process determines the geolocation of the first user device from the first redemption request.

5. (canceled)

6. (canceled)

7. (canceled)

8. The method of claim 1, wherein:
the transferring of the first redemption reward includes recording, in a distributed ledger, a record of the transfer of the first redemption reward to the first user.

9. (canceled)

10. A method of managing transactions made by end users, the method comprising:
generating, by a processor, an information payload for each of a plurality of units of a first product, including a first unit information payload for a first unit of the first product, the first unit information payload for the first unit of the first product being different from a second unit information payload for a second unit of the first product, the first unit information payload for the first unit of the first product including:
a first unique identifier for the first unit information payload;
a first redemption reward metric for the first unit of the first product, the first redemption reward metric identifying a plurality of available digital rewards transferrable, by the processor, to a user based on a redemption process;
generating, by the processor, a unique detectable identifier for each information payload, including a first detectable identifier for the first unit information payload, the first detectable identifier associated with the first unique identifier for the first unit information payload, the first detectable identifier configured to cause a user device to perform a first action when the first detectable identifier is detected by the user device, the first action including:
sending, to the processor, a first redemption request, the first redemption request including the first unique identifier for the first unit information payload; and
responsive to receiving, by the processor, the first redemption request from a first user device of a first user, performing the redemption process for the first redemption request, the redemption process including:
obtaining a first user information set for the first user;
obtaining, based on the first unique identifier for the first unit information payload in the first redemption request, the first unit information payload;
selecting, based on the first user information set for the first user, a first digital reward from among the plurality of digital rewards in the first redemption reward metric, the selecting of the first digital reward from among the plurality of digital rewards in the first redemption reward metric based on one or more of the following:
a geolocation of the first user; and/or
a timestamp associated with the first redemption request; and/or
one or more information in the first user information set; and
transferring, by the processor to the first user, the selected first digital reward.

11. The method of claim 10, wherein:
the first unit information payload further includes:
a first redemption status for the first unit information payload, the first redemption status for the first unit information payload being:
an unredeemed status when the first digital reward has not yet been transferred to a user based on the redemption process; or
a redeemed status when the first digital reward has been transferred to a user based on the redemption process;
the redemption process further includes:
identifying the first redemption status for the first unit information payload; and
the first digital reward is transferred to the first user when the first redemption status is the unredeemed status.

12. (canceled)

13. (canceled)

14. (canceled)

15. (canceled)

16. The method of claim 10, wherein at least one of the following apply:
the first redemption request further includes the geolocation of the first user device;
the redemption process determines the geolocation of the first user device from the first redemption request
the first detectable identifier is a unique QR code;
the first detectable identifier is detected by the first user device via image capturing of the unique QR code;
the first detectable identifier includes at least one of the following:
a unique QR code; and/or
a unique bar code; and/or
a unique sequence of characters.
the first user information set includes:
a geolocation of the first user; and
the first digital reward is selected based on a geolocation of the first user;
the first user information set includes:
a history of previous redemption requests from the first user;
the first digital reward is selected based on a history of previous redemption requests from the first user;
the first user information set includes:
an address of a digital wallet of the first user;
the transferring of the first digital reward includes transferring the first digital reward to an address of a digital wallet of the first user; and
the first digital reward includes at least one of the following:
a digital stamp;
a digital badge;
a feature on the digital badge;
a quantity of digital tokens; or
a digital coupon.

17. (canceled)

18. The method of claim 10, wherein:
the transferring of the first digital reward includes recording, in a distributed ledger, a record of the transfer of the first digital reward to the first user.

19. (canceled)

20. A method of managing transactions made by end users, the method comprising:
providing a first detectable identifier for a first unit of a first product, the first detectable identifier for the first unit of the first product being different from a second detectable identifier for a second unit of the first product, the first detectable identifier including instructions which, when detected by a user device, causes the user device to send, to a processor, a first redemption request; and
responsive to receiving, by the processor, the first redemption request from a first user device of a first user, performing a redemption verification process for the first redemption request, the redemption verification process including:
obtaining, based on the first redemption request, a first unit information payload for the first unit of the first product, the first unit information payload including:
a first redemption reward for the first unit of the first product; and
a first redemption status, the first redemption status being an unredeemed status or a redeemed status;
identifying the first redemption status for the first unit information payload; and
responsive to a determination that the first redemption status is the unredeemed status:
transferring, by the processor to the first user, the first redemption reward.

21. (canceled)

22. The method of claim 20, wherein at least one of the following apply:
the first unit information payload further includes:
a first expiry date for the first unit information payload, the first expiry date being a last date on which the first redemption reward can be transferred to a user based on the redemption verification process;
wherein the redemption verification process further includes:
determining a current date; and
identifying the first expiry date for the first unit information payload; and
wherein the first redemption reward is transferred to the first user when the current date has not exceeded the first expiry date;
the first unit information payload further includes:
a first geolocation restriction for the first unit information payload, the first geolocation restriction including at least one of the following:
one or more allowed geolocation regions; or
one or more restricted geolocation regions;
wherein the redemption verification process further includes:
determining a geolocation of the first user device; and
identifying the one or more allowed geolocation regions and/or one or more restricted geolocation regions; and
wherein the first redemption reward is transferred to the first user when at least one of the following are satisfied:
the geolocation of the first user device is within one or more of the allowed geolocation regions; or
the geolocation of the first user device is not within one or more of the restricted geolocation regions;
the first redemption request further includes a geolocation of the first user device, and the redemption verification process determines a geolocation of the first user device from the first redemption request
the first detectable identifier is a unique QR code, and the first detectable identifier is detected by the first user device via image capturing of the unique QR code;
the first detectable identifier includes at least one of the following:
a unique QR code; and/or
a unique bar code; and/or
a unique sequence of characters.
the first redemption reward includes at least one of the following:
a digital stamp;
a digital badge;
a feature on the digital badge;
a quantity of digital tokens; or
a digital coupon.

23. (canceled)

24. (canceled)

25. (canceled)

26. The method of claim 20, wherein:
the transferring of the first redemption reward includes recording, in a distributed ledger, a record of the transfer of the first redemption reward to the first user.

27. (canceled)

28. A method of managing transactions made by end users, the method comprising:
providing a first unique QR code for a first unit of a first product, the first unique QR code for the first unit of the first product being different from a second unique QR code for a second unit of the first product, the first unique QR code including instructions which, when scanned by a user device, causes the user device to send, to a processor, a first redemption request; and
responsive to receiving, by the processor at a first time, the first redemption request from a first user device of a first user, performing a redemption verification process for the first redemption request, the redemption verification process including:
obtaining, based on the first redemption request, a first unit information payload for the first unit of the first product, the first unit information payload including:
a first redemption reward for the first unit of the first product; and
a first redemption status, the first redemption status being:
an unredeemed status when the processor has not received the first redemption request prior to the first time;
a redeemed status when the processor has received the first redemption request before the first time;
identifying the first redemption status for the first unit information payload; and
responsive to a determination that the first redemption status is the unredeemed status:
transferring, by the processor to the first user, the first redemption reward.

29. (canceled)

30. The method of claim 28, wherein at least one of the following apply:
the first unit information payload further includes:
a first geolocation restriction for the first unit information payload, the first geolocation restriction including:
one or more allowed geolocation regions; and/or
one or more restricted geolocation regions;
the redemption verification process further includes:
determining a geolocation of the first user device; and
identifying the one or more allowed geolocation regions and/or one or more restricted geolocation regions;
the first redemption reward is transferred to the first user when at least one of the following are satisfied:
the geolocation of the first user device is within one or more of the allowed geolocation regions; or
the geolocation of the first user device is not within one or more of the restricted geolocation regions;
the first redemption reward includes at least one of the following:
a digital stamp; and/or
a digital badge; and/or
a feature on the digital badge; and/or
a quantity of digital tokens; and/or
a digital coupon.

31. The method of claim 30, wherein:
the first redemption request further includes the geolocation of the first user device; and
the redemption verification process determines the geolocation of the first user device from the first redemption request.

32. The method of claim 28, wherein:
the transferring of the first redemption reward includes recording, in a distributed ledger, a record of the transfer of the first redemption reward to the first user.

33. (canceled)

34. A method of managing transactions made by end users, the method comprising:
providing a first detectable identifier for a first unit of a first product, the first detectable identifier associated with a first unique identifier for the first unit of the first product, the first detectable identifier configured to cause a user device to perform a first action when the first detectable identifier is detected by the user device, the first action including:
sending, to a processor, a first redemption request, the first redemption request including the first unique identifier for the first unit of the first product;
providing a second detectable identifier for a second unit of the first product, the second detectable identifier associated with a second unique identifier for the second unit of the first product, the second detectable identifier configured to cause the user device to perform a second action when the second detectable identifier is detected by the user device, the second action including:
sending, to the processor, a second redemption request, the second redemption request including the second unique identifier for the second unit of the first product;
responsive to receiving, by the processor at a first time, the first redemption request from a first user device of a first user, performing a first redemption process for the first redemption request, the first redemption process including:
obtaining a first user information set for the first user;
obtaining, based on the first unique identifier in the first redemption request, a first unit information payload, the first unit information payload including:
the first unique identifier for the first unit of the first product;
a first redemption reward for the first unit of the first product; and
a first redemption status, the first redemption status being an unredeemed status;
responsive to a determination that the first redemption status is the unredeemed status:
transferring, by the processor to the first user based on the first user information set, the first redemption reward; and
changing the first redemption status for the first unit information payload from the unredeemed status to the redeemed status;
responsive to receiving, by the processor at a second time after the first time, the first redemption request from the first user device of the first user, performing the first redemption process for the first redemption request, the first redemption process including:
obtaining the first user information set for the first user;
obtaining, based on the first unique identifier in the first redemption request, the first unit information payload, the first unit information payload including:
the first unique identifier for the first unit of the first product;
the first redemption reward for the first unit of the first product; and
the first redemption status, the first redemption status being the redeemed status; and
responsive to a determination that the first redemption status is the redeemed status:
sending, by the processor to the first user, a notification that the first redemption reward for the second unit of the first product has already been redeemed;
responsive to receiving, by the processor at a third time, the second redemption request from the first user device of the first user, performing a second redemption process for the second redemption request, the second redemption process including:
obtaining the first user information set for the first user;
obtaining, based on the second unique identifier in the second redemption request, a second unit information payload, the second unit information payload including:
the second unique identifier for the second unit of the first product;
a second redemption reward for the second unit of the first product; and
a second redemption status, the second redemption status being the unredeemed status;
responsive to a determination that the second redemption status is the unredeemed status:
transferring, by the processor to the first user based on the first user information set, the second redemption reward; and
changing the second redemption status for the second unit information payload from the unredeemed status to the redeemed status;
responsive to receiving, by the processor at a fourth time after the first time, the first redemption request from a second user device of a second user, performing the first redemption process for the first redemption request, the first redemption process including:
obtaining a second user information set for the second user;
obtaining, based on the first unique identifier in the first redemption request, the first unit information payload, the first unit information payload including:
the first redemption reward for the first unit of the first product; and
the first redemption status, the first redemption status being the redeemed status; and
responsive to a determination that the first redemption status is the redeemed status:
sending, by the processor to the second user, a notification that the first redemption reward for the first unit of the first product has already been redeemed; and
responsive to receiving, by the processor at a fifth time after the third time, the second redemption request from the second user device of the second user, performing the second redemption process for the second redemption request, the second redemption process including:
obtaining the second user information set for the second user;
obtaining, based on the second unique identifier in the second redemption request, the second unit information payload, the second unit information payload including:
the second redemption reward for the second unit of the first product; and
the second redemption status, the second redemption status being the redeemed status; and
responsive to a determination that the second redemption status is the redeemed status:
sending, by the processor to the second user, a notification that the second redemption reward for the second unit of the first product has already been redeemed.

35. (canceled)

36. The method of claim 34, wherein
at least one of the following apply:
the first unit information payload further includes:
a first expiry date for the first unit information payload, the first expiry date being a last date on which the first redemption reward can be transferred to a user based on the first redemption process;
wherein the first redemption process further includes:
determining a current date; and
identifying the first expiry date for the first unit information payload; and
wherein the first redemption reward is transferred to the first user when the current date has not exceeded the first expiry date.
the first unit information payload further includes:
a first geolocation restriction for the first unit information payload, the first geolocation restriction including at least one of the following:
one or more allowed geolocation regions; or
one or more restricted geolocation regions;
the first redemption process further includes:
determining a geolocation of the first user device; and
identifying the one or more allowed geolocation regions and/or one or more restricted geolocation regions; and
the first redemption reward is transferred to the first user when at least one of the following are satisfied:
a geolocation of the first user device is within one or more allowed geolocation regions; or
a geolocation of the first user device is not within one or more restricted geolocation regions;
the first redemption request further includes a geolocation of the first user device, and the first redemption process determines the geolocation of the first user device from the first redemption request
the first detectable identifier is a unique QR code, and the first detectable identifier is detected by the first user device via image capturing of the unique QR code;
the first detectable identifier includes at least one of the following:
a unique QR code;
a unique bar code; or
a unique sequence of characters;
the first user information set includes a geolocation of the first user, and the first redemption reward is selectable based on the geolocation of the first user;
the first redemption reward includes at least one of the following:
a digital stamp;
a digital badge;
a feature on the digital badge;
a quantity of digital tokens; or
a digital coupon.

37. (canceled)

38. (canceled)

39. (canceled)

40. (canceled)

41. The method of claim 34, wherein:
the first user information set includes:
a history of previous redemption requests from the first user; and
the first redemption reward is selected based on the history of previous redemption requests from the first user.

42. The method of claim 34, wherein:
the first user information set includes:
an address of a digital wallet of the first user; and
the transferring of the first redemption reward includes transferring the first redemption reward to the address of the digital wallet of the first user.

43. The method of claim 34, wherein:
the transferring of the first redemption reward includes recording, in a distributed ledger, a record of the transfer of the first redemption reward to the first user.

44. (canceled)

45. (canceled)

46. (canceled)
